(19) United States
(12) Patent Application Publication
(10) Pub. No.: US 2026/0187719 A1
(43) Pub. Date: Jul. 2, 2026

(54) AI-BASED SYSTEM AND METHOD FOR AUTOMATICALLY GENERATING FINANCIAL APPLICATION FOR USERS

(71) Applicant: iCreditWorks Inc., Iselin, NJ (US)

(72) Inventors: Shankar R. Iyer, East Windsor, NJ (US); Suresh G. Nair, Robbinsville Twp, NJ (US); Vimal Umapathi, Penn Valley, PA (US); Amol Gote, Hopewell, NJ (US)

(21) Appl. No.: 19/541,512

(22) Filed: Feb. 17, 2026

Related U.S. Application Data
(63) Continuation-in-part of application No. 18/619,316, filed on Mar. 28, 2024.

(51) Int. Cl. G06Q 40/03

(52) U.S. Cl. CPC G06Q 40/03055

(57) ABSTRACT

An AI-based method and system for generating financial applications for second users, are disclosed. The AI-based method includes steps of: obtaining first data from first electronic devices associated with first users; determining first risk-based pricing options associated with projects; sending application links to second electronic devices associated with the second users; obtaining second data from the second electronic devices associated with the second users; determining whether the second users are qualified to obtain credits associated with projects, using AI model involving pre-processing the second data, extracting features, generating integrated feature, assigning weights for the features and integrated features, and determining qualification scores for assessing qualification of the second users; obtaining confirmed information associated with projects, from the second electronic devices of the second users; obtaining third data associated with identities of second users; generating the financial applications for payment processes; and providing an output of the financial applications.

### CROSS REFERENCE TO RELATED APPLICATION(S)

The present application is a continuation-in-part of U.S. patent application Ser. No. 18/619,316, filed on Mar. 28, 2024, and titled “ARTIFICIAL INTELLIGENCE BASED COMPUTING SYSTEM AND METHOD FOR GENERATING FINANCIAL APPLICATION FOR USERS”.

### FIELD OF INVENTION

Embodiments of the present disclosure relate to artificial intelligence based (AI-based) systems, and more particularly relates to an AI-based method and system for automatically generating one or more financial applications for one or more users (e.g., one or more customers).

### BACKGROUND

The customary procedure for seeking financial assistance including at least one of credit cards, personal loans, car loans, mortgages, and the like, typically involves an applicant (e.g., a customer) reaching out to a recipient (e.g., a lender), either in person or through a phone call. The applicant is then required to complete a loan application, either verbally or in writing, which is later reviewed by the lender. In some cases, there may be multiple lenders involved, allowing the applicant to evaluate costs and features of potential loans. If the lender rejects the loan application, the applicant may need to explore alternative lending options. Alternatively, an information or a finance broker (e.g., a vendor/merchant) can handle the task of consulting multiple lenders on behalf of the applicant, comparing available options.

In another aspect, if the applicant possesses favourable credit scores, and if the costs and features of the potential loans provided by the lenders/vendors are not satisfied to the applicant, the vendor/lender may have to convince the applicant for getting the loans from the lender. For this, the vendor communicates the applicant with the best offers (e.g., lower interest rates, discount rates, and the like) for convincing the applicants to obtain the loans. However, the procedures including at least one of: completing an application form, assembling required documents, participating in an interview with the lender, and validating submitted information, should be repeated until the applicant gets convinced for getting the loans.

Hence, the applicant needs to provide their information often when the vendor provides the best offers to the applicant. Further, the information needs to be verified manually whenever the applicant provides their information to the vendors, which consumes more time. Since, the manual process is involved in verification, the accuracy and efficiency of the loan approval process are not fulfilled.

Hence, there is a need for an improved artificial intelligence based (AI-based) system and method for automatically generating one or more financial applications for one or more users, in order to address the aforementioned issues.

### SUMMARY

This summary is provided to introduce a selection of concepts, in a simple manner, which is further described in the detailed description of the disclosure. This summary is neither intended to identify key or essential inventive concepts of the subject matter nor to determine the scope of the disclosure.

In accordance with an embodiment of the present disclosure, an artificial intelligence based (AI-based) method for automatically generating one or more financial applications for one or more second users, is disclosed. The AI-based method comprises obtaining, by one or more hardware processors, one or more first data from one or more first electronic devices associated with one or more first users. The one or more first data comprise at least one of: name, phone number, and address, of the one or more second users, one or more project categories, estimation of one or more projects, and time duration of the one or more projects being completed. The AI-based method further comprises determining, by the one or more hardware processors, one or more first risk-based pricing options associated with the one or more projects based on the one or more first data obtained from the one or more first electronic devices associated with the one or more first users. The AI-based method further comprises sending, by the one or more hardware processors, one or more application links to one or more second electronic devices associated with the one or more second users for the one or more second electronic devices to initiate one or more applications.

The AI-based method further comprises obtaining, by the one or more hardware processors, one or more second data from the one or more second electronic devices associated with the one or more second users. The one or more second data comprise at least one of: the name, the phone number, the address, at least last four digits of a social security number (SSN), birth date, and annual income, of the one or more second users, an amount requested by the one or more second users, and an option for one or more third users to be added to the one or more second users.

The AI-based method further comprises determining, by the one or more hardware processors, whether the one or more second users are qualified to obtain one or more credits associated with the one or more projects using an artificial intelligence (AI) model, by: (a) obtaining, by the one or more hardware processors, the one or more second data from the one or more second electronic devices associated with the one or more second users; (b) pre-processing, by the one or more hardware processors, the one or more second data to generate one or more pre-processed data, wherein pre-processing the one or more second data comprises at least one of: normalizing the one or more second data to one or more standardized formats, identifying and managing one or more missing data fields in the one or more second data, and validating the one or more second data against one or more pre-defined data formats and ranges; (c) extracting, by the one or more hardware processors, one or more features from the one or more second data, wherein the one or more features comprise at least one of: a debt-to-income ratio, a credit utilization ratio, a payment history pattern, an employment stability indicator, a residential stability indicator, and an income verification indicator, of the one or more second users; (d) generating, by the one or more hardware processors, one or more integrated features by combining the extracted one or more features, wherein the one or more integrated features comprise at least one of: a financial stability score, a risk exposure indicator, and a repayment capacity indicator; (e) assigning, by the one or more hardware processors, one or more weights to each of at least one of: the one or more features and the one or more integrated features, wherein the one or more weights are assigned to each of at least one of: the one or more features and the one or more integrated features, based on historical loan performance data associated with one or more previous second users; (f) determining, by the one or more hardware processors, one or more qualification scores for the one or more second users based on the one or more weights assigned to each of at least one of: the one or more features and the one or more integrated features, using one or more functions, wherein the one or more functions comprise at least one of: a weighted sum function, a sigmoid function, a softmax function, and a probability distribution function; and (g) determining, by the one or more hardware processors, whether the one or more second users are qualified to obtain the one or more credits associated with the one or more projects based on the one or more qualification scores determined for the one or more second users.

The AI-based method further comprises sending, by the one or more hardware processors, the determined one or more first risk-based pricing options associated with the one or more projects to the one or more second electronic devices of the one or more second users when the one or more second users are qualified to obtain the one or more credits associated with the one or more projects. The AI-based method further comprises determining, by the one or more hardware processors, whether the one or more second electronic devices of the one or more second users accept the one or more first risk-based pricing options associated with the one or more projects. The AI-based method further comprises determining, by the one or more hardware processors, one or more second risk-based pricing options associated with the one or more projects to be sent to the one or more second electronic devices of the one or more second users when the one or more second electronic devices of the one or more second users reject the one or more first risk-based pricing options associated with the one or more projects.

The AI-based method further comprises obtaining, by the one or more hardware processors, one or more confirmed information associated with the one or more projects, from the one or more second electronic devices of the one or more second users. The one or more confirmed information associated with the one or more projects comprise at least one of: one or more names associated with the one or more first users, one or more categories of works associated with the one or more projects, estimation of the works associated with the one or more projects, the time duration of the one or more projects, information associated with one or more ownerships, one or more categories of one or more properties of the one or more second users. The AI-based method further comprises obtaining, by the one or more hardware processors, one or more third data associated with one or more identities of the one or more second users to map the one or more second data with the one or more third data. The AI-based method further comprises generating, by the one or more hardware processors, the one or more financial applications comprising one or more agreement based electronic documents for one or more payment processes, wherein the one or more agreement based electronic documents comprise at least one of: information associated with one or more credit amounts, and one or more truth in lending agreements (TILA). The AI-based method further comprises providing, by the one or more hardware processors, an output of the generated one or more financial applications in form of the one or more agreement based electronic documents on a user interface associated with the one or more second electronic devices of the one or more second users.

In an embodiment, the AI-based method further comprises: (a) selecting, by the one or more hardware processors, the one or more projects from a list of one or more ongoing projects associated with the one or more second users; (b) generating, by the one or more hardware processors, one or more first options associated with the one or more projects; (c) obtaining, by the one or more hardware processors, at least one first option associated with the one or more projects selected by the one or more first electronic devices of the one or more first users; (d) sending, by the one or more hardware processors, the at least one first option selected by the one or more first electronic devices of the one or more first users, to the one or more second electronic devices of the one or more second users; (e) determining, by the one or more hardware processors, whether the one or more second users accept the at least one first option through the one or more second electronic devices; (e) initiating, by the one or more hardware processors, the one or more payment processes when the one or more second electronic devices of the one or more second users accept the at least one first option; and (f) re-sending, by the one or more hardware processors, the at least one first option selected by the one or more first electronic devices of the one or more first users, to the one or more second electronic devices of the one or more second users, upon contacting with the one or more second users through the one or more second electronic devices when the one or more second users reject the at least one first option through the one or more second electronic devices. The one or more first options comprise at least one of: creation of one or more payment requests, one or more update statuses of the one or more projects, one or more updated details of the one or more projects.

In another embodiment, the AI-based method further comprising training, by the one or more hardware processors, the AI model through a multi-stage training process that comprises: (a) obtaining, by the one or more hardware processors, historical qualification data from one or more data sources, wherein the historical qualification data comprise at least one of: historical second data, historical qualification outcomes, historical loan performance data, and historical repayment data, associated with the one or more previous second users; (b) pre-processing, by the one or more hardware processors, the historical qualification data to generate pre-processed training data; (c) extracting, by the one or more hardware processors, one or more training features from the pre-processed training data; (d) configuring, by the one or more hardware processors, one or more hyperparameters for the AI model, wherein the one or more hyperparameters comprise at least one of: a learning rate, a batch size, a number of epochs, a number of hidden layers, a number of nodes in each hidden layer, a dropout rate, a regularization strength, a momentum value, and a decay rate; (e) training, by the one or more hardware processors, the AI model based on at least one of: the one or more training features, the historical qualification outcomes, and the one or more hyperparameters, to learn the one or more weights associated with the one or more training features; (f) validating, by the one or more hardware processors, performance of the trained AI model using validation data; and (g) deploying, by the one or more hardware processors, the trained AI model for determining whether the one or more second users are qualified to obtain the one or more credits associated with the one or more projects.

In yet another embodiment, validating the performance of the trained AI model using the validation data, comprises: (a) splitting, by the one or more hardware processors, the historical qualification data into training data and the validation data; (b) determining, by the one or more hardware processors, one or more performance metrics based on the validation data, wherein the one or more performance metrics comprise at least one of: an accuracy metric, a precision metric, a recall metric, an F1 score metric, an area under the receiver operating characteristic curve metric, and an area under the precision-recall curve metric; (c) performing, by the one or more hardware processors, hyperparameter tuning to adjust the one or more hyperparameters of the AI model based on the one or more performance metrics; and (d) retraining, by the one or more hardware processors, the AI model periodically based on updated historical qualification data, wherein the retraining of the AI model is triggered based on at least one of: a predetermined time interval, a predetermined number of new qualification determinations, and a detected decrease in the one or more performance metrics.

In yet another embodiment, the AI-based method further comprises: (a) providing, by the one or more hardware processors, one or more second options to the one or more second electronic devices of the one or more second users to add the one or more third users; (b) obtaining, by the one or more hardware processors, one or more fourth data associated with the one or more third users from at least one of: the one or more second electronic devices of the one or more second users and one or more third electronic devices of the one or more third users. The one or more fourth data associated with the one or more third users comprise at least one of: the name, the phone number, the address, the at least last four digits of a social security number (SSN), the birth date, and the annual income, of the one or more third users.

In yet another embodiment, the AI-based method further comprises: (a) determining, by the one or more hardware processors, whether the one or more second users hold at least one of: the one or more first risk-based pricing options and the one or more second risk-based pricing options, associated with the one or more projects within a predetermined time duration; and (b) sending, by the one or more hardware processors, one or more reminder messages to at least one of: the one or more first electronic devices of the one or more first users and the one or more second electronic devices of the one or more second users when the one or more second users hold at least one of: the one or more first risk-based pricing options and the one or more second risk-based pricing options, associated with the one or more projects within the predetermined time duration.

In yet another embodiment, the AI-based method further comprises: (a) generating, by the one or more hardware processors, one or more summaries associated with the one or more credits to be sent to the one or more second electronic devices of the one or more second users upon mapping of the one or more second data with the one or more third data; (b) determining, by the one or more hardware processors, one or more credit qualifications of the one or more second users based on a hard pull process through a global distribution system (GDS); and (c) generating, by the one or more hardware processors, the one or more financial applications in the form of the one or more agreements for one or more payment processes when the one or more credit qualifications of the one or more second users exceed one or more predetermined value.

In yet another embodiment, the AI-based method further comprises validating, by the one or more hardware processors, the one or more first users based on a clear identity confirm process, by: (a) obtaining, by the one or more hardware processors, one or more fifth data associated with the one or more first users from the one or more first electronic devices of the one or more first users; (b) comparing, by the one or more hardware processors, the one or more fifth data associated with the one or more first users with one or more first prestored data associated with the one or more first users retrieved from one or more clear databases; (c) generating, by the one or more hardware processors, one or more confidence scores for the one or more first users based on the comparison of the one or more fifth data associated with the one or more first users with the one or more first prestored data associated with the one or more first users; (d) classifying, by the one or more hardware processors, the one or more first users based on the one or more confidence scores generated for the one or more first users; and (e) determining, by the one or more hardware processors, whether the one or more first electronic devices of the one or more first users need to provide one or more sixth data based on the classification of the one or more first users.

In yet another embodiment, further comprising: (a) obtaining, by the one or more hardware processors, one or more inputs from the one or more first electronic devices of the one or more first users; (b) comparing by the one or more hardware processors, the one or more inputs with one or more second prestored data based on a clear risk inform search process; (c) generating, by the one or more hardware processors, one or more risk scores for the one or more first users based on the comparison of the one or more inputs with the one or more second prestored data; and (d) determining, by the one or more hardware processors, one or more optimum first users based on the one or more risk scores generated for the one or more first users. The one or more inputs comprise a selection of one or more entities on which the one or more first users are belonging to.

In yet another embodiment, the AI-based method further comprising: (a) capturing, by one or more camera sensors of the one or more second electronic devices, one or more images of the one or more identities of the one or more second users; (b) performing, by the one or more hardware processors, ID classification and detection on-device by a custom machine learning model built using transfer learning based on a YOLOv8 architecture; (c) distinguishing, by the one or more hardware processors, a real ID card from look-alike documents comprising at least one of: credit cards and membership cards, using the custom machine learning model; (d) classifying, by the one or more hardware processors, an ID type and a state associated with the government-issued identification document, using the custom machine learning model; (e) extracting, by the one or more hardware processors, an ID template as a vector from the one or more valid documents associated with the one or more identities; (f) verifying, by the one or more hardware processors, the one or more identities of the one or more second users by submitting the ID template vector to a third-party DMV-integrated security service for server-side validation; (g) performing, by the one or more hardware processors, a liveness check locally on-device; (h) extracting, by the one or more hardware processors, a biometric vector from a face image of the one or more second users using a FaceNet embedding model; (i) generating, by the one or more hardware processors, a device blueprint by extracting device-specific features from the one or more second electronic devices; (j) running, by the one or more hardware processors, a customer confidence machine learning model over device features, transactional features, financial features, social features, and behavioral features; (k) generating, by the one or more hardware processors, a final security level based on outputs from at least one of: the ID verification, the liveness check, the biometric extraction, the device blueprint, and the customer confidence machine learning model; and (l) gating, by the one or more hardware processors, an onboarding flow via a rule engine based on the final security level, wherein the rule engine determines at least one of: a step-up action, a reject action, and a proceed action, associated with the one or more payment processes.

In one aspect, an artificial intelligence based (AI-based) system for automatically generating one or more financial applications for one or more second users, is disclosed. The AI-based system includes one or more hardware processors and a memory coupled to the one or more hardware processors. The memory includes a plurality of subsystems in the form of programmable instructions executable by the one or more hardware processors. The plurality of subsystems comprises a data obtaining subsystem configured to obtain one or more first data from one or more first electronic devices associated with one or more first users. The one or more first data comprise at least one of: a name, a phone number, and an address, of the one or more second users, one or more project categories, an estimation of one or more projects, and a duration of the one or more projects being completed. The plurality of subsystems further comprises a risk-based price determining subsystem configured to determine one or more first risk-based pricing options associated with the one or more projects based on the one or more first data obtained from the one or more first electronic devices associated with one or more first users.

The plurality of subsystems further comprises a data transmission subsystem configured to send one or more application links to one or more second electronic devices associated with the one or more second users for the one or more second electronic devices to initiate one or more applications. The plurality of subsystems further comprises the data obtaining subsystem configured to obtain one or more second data from the one or more second electronic devices associated with the one or more second users. The one or more second data comprise at least one of: the name, the phone number, the address, at least last four digits of a social security number (SSN), birth date, and annual income, of the one or more second users, an amount requested by the one or more second users, and an option for one or more third users to be added to the one or more second users.

The plurality of subsystems further comprises a qualification determining subsystem configured to determine whether the one or more second users are qualified to obtain one or more credits associated with the one or more projects using an artificial intelligence (AI) model, by: (a) obtaining the one or more second data from the one or more second electronic devices associated with the one or more second users; (b) pre-processing the one or more second data to generate one or more pre-processed data, wherein pre-processing the one or more second data comprises at least one of: normalizing the one or more second data to one or more standardized formats, identifying and managing one or more missing data fields in the one or more second data, and validating the one or more second data against one or more pre-defined data formats and ranges; (c) extracting one or more features from the one or more second data, wherein the one or more features comprise at least one of: a debt-to-income ratio, a credit utilization ratio, a payment history pattern, an employment stability indicator, a residential stability indicator, and an income verification indicator, of the one or more second users; (d) generating one or more integrated features by combining the extracted one or more features, wherein the one or more integrated features comprise at least one of: a financial stability score, a risk exposure indicator, and a repayment capacity indicator; (e) assigning one or more weights to each of at least one of: the one or more features and the one or more integrated features, wherein the one or more weights are assigned to each of at least one of: the one or more features and the one or more integrated features, based on historical loan performance data associated with one or more previous second users; (f) determining one or more qualification scores for the one or more second users based on the one or more weights assigned to each of at least one of: the one or more features and the one or more integrated features, using one or more functions, wherein the one or more functions comprise at least one of: a weighted sum function, a sigmoid function, a softmax function, and a probability distribution function; and (g) determining whether the one or more second users are qualified to obtain the one or more credits associated with the one or more projects based on the one or more qualification scores determined for the one or more second users.

The plurality of subsystems further comprises the data transmission subsystem further configured to send the determined one or more first risk-based pricing options associated with the one or more projects to the one or more second electronic devices of the one or more second users when the one or more second users are qualified to obtain the one or more credits associated with the one or more projects. The plurality of subsystems further comprises the risk-based price determining subsystem further configured to: (a) determine, whether the one or more second electronic devices of the one or more second users accept the one or more first risk-based pricing options associated with the one or more projects; and (b) determine one or more second risk-based pricing options associated with the one or more projects to be sent to the one or more second electronic devices of the one or more second users when the one or more second electronic devices of the one or more second users reject the one or more first risk-based pricing options associated with the one or more projects.

The plurality of subsystems further comprises the data obtaining subsystem further configured to obtain one or more confirmed information associated with the one or more projects, from the one or more second electronic devices of the one or more second users; and obtain one or more third data associated with one or more identities of the one or more second users to map the one or more second data with the one or more third data. The one or more confirmed information associated with the one or more projects comprise at least one of: one or more names associated with the one or more first users, one or more categories of works associated with the one or more projects, estimation of the works associated with the one or more projects, the time duration of the one or more projects, information associated with one or more ownerships, one or more categories of one or more properties of the one or more second users. The plurality of subsystems further comprises a financial application generation subsystem configured to generate the one or more financial applications comprising one or more agreement based electronic documents for one or more payment processes. The one or more agreement based electronic documents comprise at least one of: information associated with one or more credit amounts, and one or more truth in lending agreements (TILA). The plurality of subsystems further comprises an output subsystem configured to provide an output of the generated one or more financial applications in form of the one or more agreement based electronic documents on a user interface associated with the one or more second electronic devices of the one or more second users.

In another aspect, a non-transitory computer-readable storage medium having instructions stored therein that, when executed by a hardware processor, causes the processor to perform method steps as described above.

To further clarify the advantages and features of the present disclosure, a more particular description of the disclosure will follow by reference to specific embodiments thereof, which are illustrated in the appended figures. It is to be appreciated that these figures depict only typical embodiments of the disclosure and are therefore not to be considered limiting in scope. The disclosure will be described and explained with additional specificity and detail with the appended figures.

### BRIEF DESCRIPTION OF DRAWINGS

The disclosure will be described and explained with additional specificity and detail with the accompanying figures in which:

FIG. 1 is a block diagram illustrating a computing environment with an artificial intelligence based (AI-based) system for automatically generating one or more financial applications for one or more second users, in accordance with an embodiment of the present disclosure;

FIG. 2 is a detailed view of the AI-based system for automatically generating the one or more financial applications for the one or more second users, in accordance with another embodiment of the present disclosure;

FIG. 3A-3E is an overall process flow of generating the one or more financial applications for the one or more second users, in accordance with another embodiment of the present disclosure; and

FIG. 4A-4D is a flow chart illustrating an artificial intelligence based (AI-based) method for automatically generating the one or more financial applications for the one or more second users, in accordance with an embodiment of the present disclosure.

Further, those skilled in the art will appreciate that elements in the figures are illustrated for simplicity and may not have necessarily been drawn to scale. Furthermore, in terms of the construction of the device, one or more components of the device may have been represented in the figures by conventional symbols, and the figures may show only those specific details that are pertinent to understanding the embodiments of the present disclosure so as not to obscure the figures with details that will be readily apparent to those skilled in the art having the benefit of the description herein.

### DETAILED DESCRIPTION OF THE DISCLOSURE

For the purpose of promoting an understanding of the principles of the disclosure, reference will now be made to the embodiment illustrated in the figures and specific language will be used to describe them. It will nevertheless be understood that no limitation of the scope of the disclosure is thereby intended. Such alterations and further modifications in the illustrated system, and such further applications of the principles of the disclosure as would normally occur to those skilled in the art are to be construed as being within the scope of the present disclosure. It will be understood by those skilled in the art that the foregoing general description and the following detailed description are exemplary and explanatory of the disclosure and are not intended to be restrictive thereof.

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

The terms “comprise”, “comprising”, or any other variations thereof, are intended to cover a non-exclusive inclusion, such that one or more devices or sub-systems or elements or structures or components preceded by “comprises . . . a” does not, without more constraints, preclude the existence of other devices, sub-systems, additional sub-modules. Appearances of the phrase “in an embodiment”, “in another embodiment” and similar language throughout this specification may, but not necessarily do, all refer to the same embodiment.

Unless otherwise defined, all technical and scientific terms used herein have the same meaning as commonly understood by those skilled in the art to which this disclosure belongs. The system, methods, and examples provided herein are only illustrative and not intended to be limiting.

A computer system (standalone, client or server computer system) configured by an application may constitute a “module” (or “subsystem”) that is configured and operated to perform certain operations. In one embodiment, the “module” or “subsystem” may be implemented mechanically or electronically, so a module includes dedicated circuitry or logic that is permanently configured (within a special-purpose processor) to perform certain operations. In another embodiment, a “module” or “subsystem” may also comprise programmable logic or circuitry (as encompassed within a general-purpose processor or other programmable processor) that is temporarily configured by software to perform certain operations.

Accordingly, the term “module” or “subsystem” should be understood to encompass a tangible entity, be that an entity that is physically constructed, permanently configured (hardwired) or temporarily configured (programmed) to operate in a certain manner and/or to perform certain operations described herein.

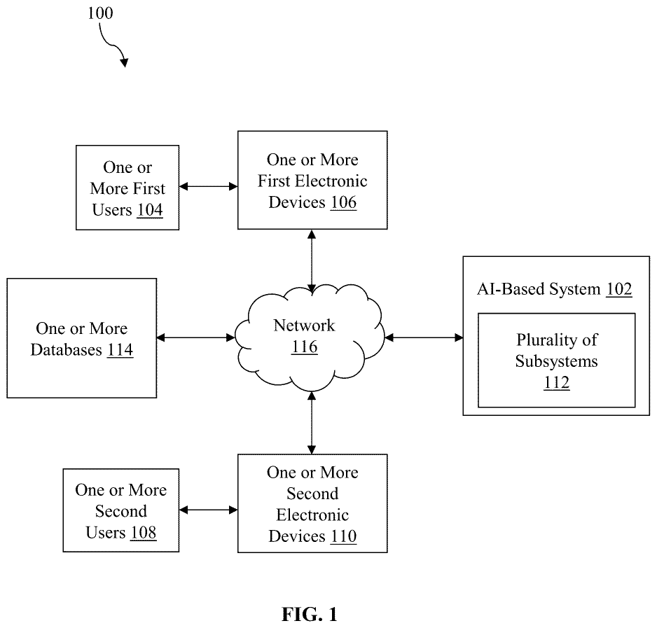

Referring now to the drawings, and more particularly to FIG. 1 through FIG. 4D, where similar reference characters denote corresponding features consistently throughout the figures, there are shown preferred embodiments and these embodiments are described in the context of the following exemplary system and/or method.

FIG. 1 is a block diagram illustrating a computing environment 100 with an artificial intelligence based (AI-based) system 102 (i.e., AI-based computing system) for automatically generating one or more financial applications for one or more second users 108, in accordance with an embodiment of the present disclosure. According to FIG. 1, the computing environment 100 includes one or more first electronic devices 106 and one or more second electronic devices 110, which are communicatively coupled to the AI-based system 102 through a network 116. The one or more first electronic devices 106 and the one or more second electronic devices 110, through which one or more first users 104 and the one or more second users 108 respectively provide one or more inputs to the AI-based system 102. In an embodiment, the one or more first users 104 may include at least one of: one or more vendors, one or more merchants, one or more brokers, one or more contractors, and the like. In an embodiment, the one or more second users 108 may include one or more customers, one or more organizations, one or more individuals within the one or more organizations, and the like.

The present invention is configured to automatically generate the one or more financial applications for the one or more second users (e.g., one or more customers/consumers) 108 for seeking one or more credits (e.g., one or more home improvement loans). The present invention is further configured to generate the one or more financial applications for the one or more first users 104 and the one or more second users 108 to generate quotes (risk-based pricing options/offers) for one or more projects (e.g., one or more home improvement projects). The present invention is configured to generate one or more payment processes on a contract and needs of the one or more first users 104 and the one or more second users 108.

The AI-based system 102 is initially configured to obtain one or more first data from the one or more first electronic devices 106 associated with the one or more first users 104. In an embodiment, the one or more first data may include at least one of: name, phone number, and address, of the one or more second users 108, one or more project categories, estimation of one or more projects, and time duration of the one or more projects being completed. The AI-based system 102 is further configured to determine one or more first risk-based pricing options associated with the one or more projects based on the one or more first data obtained from the one or more first electronic devices 106 associated with the one or more first users 104.

The AI-based system 102 is further configured to send one or more application links to one or more second electronic devices 110 associated with the one or more second users 108 for the one or more second electronic devices 110 to initiate one or more applications. The AI-based system 102 is further configured to obtain one or more second data from the one or more second electronic devices 110 associated with the one or more second users 108. The one or more second data may include at least one of: the name, the phone number, the address, at least last four digits of a social security number (SSN), birth date, and annual income, of the one or more second users 108, an amount requested by the one or more second users 108, and an option for one or more third users to be added to the one or more second users 108.

The AI-based system 102 is further configured to determine whether the one or more second users 108 are qualified to obtain one or more credits associated with the one or more projects by an artificial intelligence (AI) model. For determining whether the one or more second users 108 are qualified, the AI model is initially configured to obtain the one or more second data from the one or more second electronic devices associated with the one or more second users. The AI model is further configured to pre-process the one or more second data to generate one or more pre-processed data. The pre-processing of the one or more second data comprises at least one of: normalizing the one or more second data to one or more standardized formats, identifying and managing one or more missing data fields in the one or more second data, and validating the one or more second data against one or more pre-defined data formats and ranges.

The AI model is further configured to extract one or more features from the one or more second data. The one or more features may comprise at least one of: a debt-to-income ratio, a credit utilization ratio, a payment history pattern, an employment stability indicator, a residential stability indicator, and an income verification indicator, of the one or more second users. The AI model is further configured to generate one or more integrated features by combining the extracted one or more features. The one or more integrated features may include at least one of: a financial stability score, a risk exposure indicator, and a repayment capacity indicator. The AI model is further configured to assign one or more weights to each of at least one of: the one or more features and the one or more integrated features. The one or more weights are assigned to each of at least one of: the one or more features and the one or more integrated features, based on historical loan performance data associated with one or more previous second users.

The AI model is further configured to determine one or more qualification scores for the one or more second users based on the one or more weights assigned to each of at least one of: the one or more features and the one or more integrated features, using one or more functions. The one or more functions may include at least one of: a weighted sum function, a sigmoid function, a softmax function, and a probability distribution function. The AI model is further configured to determine whether the one or more second users are qualified to obtain the one or more credits associated with the one or more projects based on the one or more qualification scores determined for the one or more second users.

The AI-based system 102 is further configured to send the determined one or more first risk-based pricing options associated with the one or more projects when the one or more second users 108 are qualified to obtain the one or more credits associated with the one or more projects. The AI-based system 102 is further configured to determine whether the one or more second users 108 accept the one or more first risk-based pricing options associated with the one or more projects. The AI-based system 102 is further configured to determine one or more second risk-based pricing options associated with the one or more projects to be sent to the one or more second electronic devices 110 of the one or more second users 108 when the one or more second users 108 reject the one or more first risk-based pricing options associated with the one or more projects.

The AI-based system 102 is further configured to obtain one or more confirmed information associated with the one or more projects, from the one or more second electronic devices 110 of the one or more second users 108. In an embodiment, the one or more confirmed information associated with the one or more projects may include at least one of: one or more names associated with the one or more first users 104, one or more categories of works associated with the one or more projects, estimation of the works associated with the one or more projects, the time duration of the one or more projects, information associated with one or more ownerships, one or more categories of one or more properties of the one or more second users 108.

The AI-based system 102 is further configured to obtain one or more third data associated with one or more identities of the one or more second users 108 to map the one or more second data with the one or more third data. The AI-based system 102 is further configured to generate the one or more financial applications including one or more agreement based electronic documents for one or more payment processes. The one or more agreement based electronic documents may include at least one of: information associated with one or more credit amounts, and one or more truth in lending agreements (TILA). The AI-based system 102 is further configured to provide an output of the generated the one or more financial applications in form of the one or more agreement based electronic documents on a user interface associated with the one or more second electronic devices 110 of the one or more second users 108.

The AI-based system 102 may be hosted on a central server including at least one of: a cloud server or a remote server. In an embodiment, the AI-based system 102 may include at least one of: a user device, a server computer, a server computer over the network 116, a cloud-based computing system, a cloud-based computing system over the network 116, a distributed computing system, and the like. Further, the network 116 may be at least one of: a Wireless-Fidelity (Wi-Fi) connection, a hotspot connection, a Bluetooth connection, a local area network (LAN), a wide area network (WAN), any other wireless network, and the like. In an embodiment, the one or more first electronic devices 106 and the one or more second electronic devices 110, may include at least one of: a laptop computer, a desktop computer, a tablet computer, a Smartphone, a wearable device, a Smart watch, and the like.

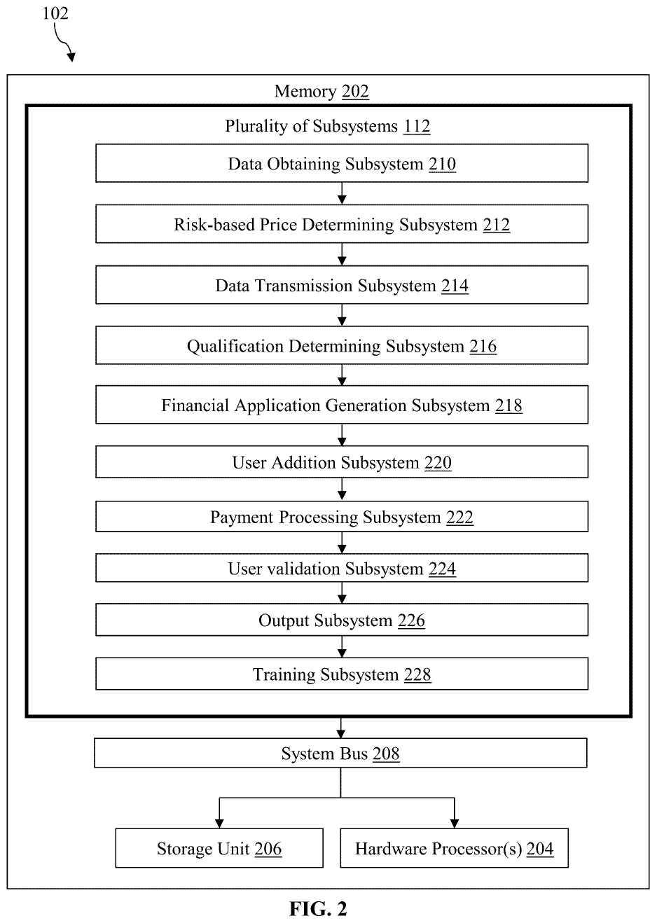

Further, the computing environment 100 includes one or more databases 114 communicatively coupled to the AI-based system 102 through the network 116. Furthermore, the one or more first electronic devices 106 and the one or more second electronic devices 110, may include at least one of: a local browser, a mobile application, and the like. Furthermore, the one or more first users 104 and the one or more second users 108, may use a web application through the local browser, the mobile application to communicate with the AI-based system 102. In an embodiment of the present disclosure, the AI-based system 102 includes a plurality of subsystems 112. Details on the plurality of subsystems 112 have been elaborated in subsequent paragraphs of the present description with reference to FIG. 2.

FIG. 2 is a detailed view of the AI-based system 102 for automatically generating the one or more financial applications for the one or more second users 108, in accordance with another embodiment of the present disclosure. The AI-based system 102 includes a memory 202, one or more hardware processors 204, and a storage unit 206. The memory 202, the one or more hardware processors 204, and the storage unit 206 are communicatively coupled through a system bus 208 or any similar mechanism. The memory 202 includes the plurality of subsystems 112 in the form of programmable instructions executable by the one or more hardware processors 204.

The plurality of subsystems 112 includes a data obtaining subsystem 210, a risk-based price determining subsystem 212, a data transmission subsystem 214, a qualification determining subsystem 216, a financial application generation subsystem 218, a user addition subsystem 220, a payment processing subsystem 222, a user validation subsystem 224, an output subsystem 226, and a training subsystem 228.

The one or more hardware processors 204, as used herein, means any type of computational circuit, including, but not limited to, at least one of: a microprocessor unit, microcontroller, complex instruction set computing microprocessor unit, reduced instruction set computing microprocessor unit, very long instruction word microprocessor unit, explicitly parallel instruction computing microprocessor unit, graphics processing unit, digital signal processing unit, or any other type of processing circuit. The one or more hardware processors 204 may also include embedded controllers, including at least one of: generic or programmable logic devices or arrays, application specific integrated circuits, single-chip computers, and the like.

The memory 202 may be non-transitory volatile memory and non-volatile memory. The memory 202 may be coupled for communication with the one or more hardware processors 204, being a computer-readable storage medium. The one or more hardware processors 204 may execute machine-readable instructions and/or source code stored in the memory 202. A variety of machine-readable instructions may be stored in and accessed from the memory 202. The memory 202 may include any suitable elements for storing data and machine-readable instructions, including at least one of: read only memory, random access memory, erasable programmable read only memory, electrically erasable programmable read only memory, a hard drive, a removable media drive for handling compact disks, digital video disks, diskettes, magnetic tape cartridges, memory cards, and the like. In the present embodiment, the memory 202 includes the plurality of subsystems 112 stored in the form of machine-readable instructions on any of the above-mentioned storage media and may be in communication with and executed by the one or more hardware processors 204. The storage unit 206 may be a cloud storage, a Structured Query Language (SQL) data store, a noSQL database or a location on a file system directly accessible by the plurality of subsystems 112.

The plurality of subsystems 112 includes the data obtaining subsystem 210 that is communicatively connected to the one or more hardware processors 204. The data obtaining subsystem 210 is configured to obtain the one or more first data from one or more first electronic devices 106 associated with the one or more first users (e.g., vendor/merchant) 104 upon the first one or more users 104 log in to a provider application. In an embodiment, a user interface of the provider application is configured to display one or more options based on a status of the one or more projects. For example, the user interface of the provider application is configured to provide an option for the one or more first users 104 to initiate a new project. The one or more projects may refer to one or more undertakings for which the one or more second users 108 seek financial assistance from the one or more first users 106. The one or more projects may include one or more home improvement projects. The provider application may refer to an application through which the one or more first users 104 log in to initiate and manage the one or more projects associated with the one or more second users 108. The provider application may be configured to display one or more options based on a status of the one or more projects, including an option for the one or more first users 104 to initiate the new project. The data obtaining subsystem 210 in the application is configured to obtain at least one of: the name, the phone number, and the address, of the one or more second users 108, the one or more project categories, the estimation of one or more projects, and the duration of the one or more projects being completed. In an embodiment, the one or more project categories may be selected from, but not limited to, at least one of: bathroom, kitchen, landscaping/outdoor project, new addition, roofing, flooring, heating, ventilation, and air conditioning (HVAC), and the like.

The plurality of subsystems 112 includes the risk-based price determining subsystem 212 that is communicatively connected to the one or more hardware processors 204. The risk-based price determining subsystem 212 is configured to determine the one or more first risk-based pricing options associated with the one or more projects based on the one or more first data obtained from the one or more first electronic devices 106 associated with one or more first users 104. The one or more first risk-based pricing options may refer to one or more loan offers or quotes associated with the one or more projects that are determined based on the one or more first data obtained from the one or more first electronic devices 106 associated with the one or more first users 104. In an embodiment, the risk-based price determining subsystem 212 is configured to select the one or more first risk-based pricing options before an application link is sent to the one or more second users (e.g., one or more consumers/customers/responsible party (RP)) 108. For example, the risk-based price determining subsystem 212 may receive the one or more first data indicating a kitchen renovation project with an estimation of $25,000 and a time duration of 3 months. Based on the one or more first data, the risk-based price determining subsystem 212 may determine the one or more first risk-based pricing options comprising a loan offer of $25,000 at an interest rate of 7.99% with a repayment term of 60 months. The risk-based price determining subsystem 212 may further determine alternative first risk-based pricing options comprising a loan offer of $25,000 at an interest rate of 9.99% with a repayment term of 36 months. In an embodiment, the risk-based price determining subsystem 212 is configured to change the one or more first risk-based pricing options before sending the application link to the one or more second users 108. The one or more first risk-based pricing options are options that is seen by the one or more second users 108 when the application is approved. The risk-based price determining subsystem 212 is further configured to save the information.

The plurality of subsystems 112 includes the data transmission subsystem 214 that is communicatively connected to the one or more hardware processors 204. The data transmission subsystem 214 is configured to send the one or more application links to the one or more second electronic devices 110 associated with the one or more second users 108 for the one or more second electronic devices 110 to initiate the one or more applications. In an embodiment, the one or more application links are sent to the one or more second users 108 through at least one of: a short message sent (SMS), an electronic mail, a social media, and the like.

When the one or more second users 108 are adapted to click on the one or more application links, the data transmission subsystem 214 is configured to send a message on the application confirming that the one or more application links are received by the one or more second users 108 and the one or more second users 108 have initiated the application. The notification may be sent to the one or more first users 104 and the application. In an embodiment, the status of the application may be updated to “in progress”. In an embodiment, the one or more second users 108 may download the application using at least one of: a quick response (QR) code and one or more play stores.

The application is configured to display one or more names and one or more phone numbers of the one or more second users 108 on a welcome screen with an option for “This is not me”. The option “This is not me” may be appeared when the one or more phone numbers used by the one or more second users 108 are not correct. If an intended recipient of the one or more application links is wrong, the application may terminate with a message to the one or more first users 104 and may inform the one or more first users 104 to update the one or more phone numbers and to resubmit. The application is configured to display the recipient a blank screen. The option “This is not me” may further be appeared when the information entered by the one or more first users 104 have errors in the information. In an embodiment, the application may allow the one or more second users 108 to update that information manually through the one or more second electronic devices 110.

When the one or more second users 108 update the information, the data transmission subsystem 214 is further configured to send a message back to the one or more first users 104 through the SMS. The message notifies that the one or more second users 108 has updated the information. The data transmission subsystem 214 may be configured to connect any information that the one or more second users 108 input on the application. In an embodiment, if the one or more second users 108 uses the QR code to connect to the one or more first users 104. The AI-based system 102 is configured to determine whether the QR code is specific or generic, and to determine whether the one or more second electronic devices 110 of the one or more second users 108 is configured to search for the one or more first users 104 to select the one or more first users 104. The AI-based system 102 is further configured to connect the one or more first users 104 to the one or more second users 108.

The data obtaining subsystem 210 is further configured to obtain the one or more second data from the one or more second electronic devices 110 associated with the one or more second users 108 when the one or more second electronic devices 110 of the one or more second users 108 are configured to click on the one or more application links associated with the one or more projects. In an embodiment, the one or more second data may include at least one of: the name, the phone number, the address, at least last four digits of a social security number (SSN), birth date, and annual income, of the one or more second users 108, an amount requested by the one or more second users 108, and an option for one or more third users to be added to the one or more second users 108.

In an embodiment, at least one of: the name, the phone number, the address, of the one or more second users 108 may be easily updated by an editing option. In an embodiment, if the address of the one or more second users 108 is not where the work would be performed, the data obtaining subsystem 210 is configured to obtain the working address of the one or more projects from the one or more second electronic devices 110 of the one or more second users 108. In an embodiment, if the address of the one or more second users 108 is a commercial property, then the data obtaining subsystem 210 is configured to obtain the address associated with the commercial property from the one or more second electronic devices 110 of the one or more second users 108. In an embodiment, if the address of the one or more second users 108 is at least one of: a primary address and a vacation home, then the data obtaining subsystem 210 is configured to obtain the address associated with at least one of: the primary address and the vacation home from the one or more second electronic devices 110 of the one or more second users 108. In an embodiment, the data obtaining subsystem 210 is configured to generate a message to the one or more second electronic devices 110 of the one or more second users 108 indicating that the AI-based system 102 does not accept non-primary residence addresses of the one or more second users 108 at a moment.

The plurality of subsystems 112 includes the qualification determining subsystem 216 that is communicatively connected to the one or more hardware processors 204. The qualification determining subsystem 216 is configured to obtain the one or more second data and verify the one or more second data from prove before prequal is submitted. In an embodiment, the data obtaining subsystem 210 is configured to obtain additional data from the one or more second electronic devices 110 of the one or more second users 108. The qualification determining subsystem 216 is further configured to determine whether the one or more second users 108 are qualified to obtain one or more credits (e.g., one or more loans) associated with the one or more projects by the artificial intelligence (AI) model. In an embodiment, the artificial intelligence (AI) model may include at least one of: a deep neural networks based AI model, a linear regression based AL model, a logistic regression based AL model, a decision trees based AL model, a random forest based AL model, and the like.

In one aspect, for determining whether the one or more second users 108 are qualified to obtain one or more credits associated with the one or more projects, the qualification determining subsystem 216 using the artificial intelligence (AI) model, is configured to obtain the one or more second data from the one or more second electronic devices 110 associated with the one or more second users 108. The qualification determining subsystem 216 is further configured to compare the one or more second data associated with the one or more second users 108 with one or more predetermined data. In an embodiment, the one or more predetermined data may include one or more prestored results associated with one or more qualifications of the one or more second users 108 for the one or more credits based on data associated with the one or more second users 108. For example, one or more prestored results associated with one or more qualifications of the one or more second users 108 may include at least one of: educational qualifications of the one or more second users 108, credit scores of the one or more second users 108, credit history of the one or more second users 108, transaction statuses of the one or more second users 108, and the like. The qualification determining subsystem 216 is further configured to determine whether the one or more second users 108 are qualified to obtain the one or more credits associated with the one or more projects, based on the comparison of the one or more second data associated with the one or more second users 108 with the one or more predetermined data.

In another aspect, for determining whether the one or more second users 108 are qualified to obtain one or more credits associated with the one or more projects, the qualification determining subsystem 216 using the artificial intelligence (AI) model, is configured to obtain the one or more second data from the one or more second electronic devices 110 associated with the one or more second users 108. The qualification determining subsystem 216 using the artificial intelligence (AI) model, is further configured to pre-process the one or more second data to generate one or more pre-processed data. Pre-processing the one or more second data includes at least one of: normalizing the one or more second data to one or more standardized formats, identifying and managing one or more missing data fields in the one or more second data, and validating the one or more second data against one or more pre-defined data formats and ranges.

The qualification determining subsystem 216 using the artificial intelligence (AI) model, is further configured to extract the one or more features from the one or more second data. The one or more features may include at least one of: the debt-to-income ratio, the credit utilization ratio, the payment history pattern, the employment stability indicator, the residential stability indicator, and the income verification indicator, of the one or more second users 108. The qualification determining subsystem 216 using the artificial intelligence (AI) model, is further configured to generate the one or more integrated features by combining the extracted one or more features. The one or more integrated features may include at least one of: the financial stability score, the risk exposure indicator, and the repayment capacity indicator.

The qualification determining subsystem 216 using the artificial intelligence (AI) model, is further configured to assign the one or more weights to each of at least one of: the one or more features and the one or more integrated features. The one or more weights are assigned to each of at least one of: the one or more features and the one or more integrated features, based on historical loan performance data associated with one or more previous second user. The qualification determining subsystem 216 using the artificial intelligence (AI) model, is further configured to determine the one or more qualification scores for the one or more second users 108 based on the one or more weights assigned to each of at least one of: the one or more features and the one or more integrated features, using the one or more functions. The one or more functions may include at least one of: a weighted sum function, a sigmoid function, a softmax function, and a probability distribution function. The qualification determining subsystem 216 using the artificial intelligence (AI) model, is further configured to determine whether the one or more second users 108 are qualified to obtain the one or more credits associated with the one or more projects based on the one or more qualification scores determined for the one or more second users 108.

The one or more second data may refer to information obtained from the one or more second electronic devices 110 associated with the one or more second users 108, comprising at least one of: the name, the phone number, the address, at least last four digits of a social security number (SSN), birth date, and annual income, of the one or more second users 108. The pre-processing may refer to preparing the one or more second data for analysis by normalizing the data to standardized formats, identifying and managing missing data fields, and validating the data against pre-defined formats and ranges. The term one or more features may refer to measurable characteristics extracted from the one or more second data, including a debt-to-income ratio indicating a percentage of income used for debt payments, a credit utilization ratio indicating a percentage of available credit being used, a payment history pattern indicating consistency of past payments, an employment stability indicator indicating duration and consistency of employment, a residential stability indicator indicating duration at current residence, and an income verification indicator indicating whether income has been verified.

The one or more integrated features may refer to combined metrics derived from the one or more features, including a financial stability score representing overall financial health, a risk exposure indicator representing potential default risk, and a repayment capacity indicator representing ability to repay the loan. The one or more weights may refer to numerical values assigned to each feature indicating relative importance in determining qualification, wherein higher weights indicate greater importance. The one or more qualification scores may refer to numerical values calculated using the weighted features through functions such as a weighted sum function, a sigmoid function, a softmax function, or a probability distribution function. The qualification scores indicate likelihood of the one or more second users being qualified for the one or more credits.

The weighted sum function may refer to a mathematical function that determines a qualification score by multiplying each of the one or more features and the one or more integrated features by their corresponding weights and summing the results. The weighted sum function may be expressed as a sum of products of feature values and their assigned weights. The sigmoid function may refer to a mathematical function that transforms the qualification score into a probability value between 0 and 1. The sigmoid function may be configured to map any input value to an output value within the range of 0 to 1, wherein output values closer to 1 indicate higher likelihood of qualification and output values closer to 0 indicate lower likelihood of qualification.

The term softmax function may refer to a mathematical function that converts the qualification score into a probability distribution across multiple qualification categories. The softmax function may be configured to generate probabilities for each qualification category, wherein the probabilities sum to 1. The qualification categories may include at least one of: fully qualified, partially qualified, and not qualified. The term probability distribution function may refer to a mathematical function that describes the likelihood of the one or more second users 108 being qualified based on the one or more features and the one or more integrated features. The probability distribution function may include at least one of: a normal distribution function, a binomial distribution function, a Poisson distribution function, and a logistic distribution function. An example with respect to the one or more functions, the AI model may determine a weighted sum of 3.5 based on the one or more features and the one or more weights, apply the sigmoid function to transform the weighted sum into a probability value of 0.97, and determine that the one or more second users 108 are qualified to obtain the one or more credits because the probability value exceeds a predetermined threshold of 0.7. In another example, the AI model may apply the softmax function to generate probabilities of 0.85 for fully qualified, 0.12 for partially qualified, and 0.03 for not qualified, and determine that the one or more second users are fully qualified based on the highest probability value.

An example with respect to the determination of the qualified one or more second users 108, the AI model may obtain second data indicating an annual income of $60,000 and monthly debt payments of $1,200 for a second user 108, pre-process the data by normalizing income to a standardized format, extract features including a debt-to-income ratio of 24% and a credit utilization ratio of 30%, generate integrated features including a financial stability score of 75 and a repayment capacity indicator of 80, assign weights of 0.3 to the debt-to-income ratio and 0.25 to the financial stability score based on historical loan performance data, calculate a qualification score of 78 using a weighted sum function, and determine that the second user 108 is qualified to obtain the credits because the qualification score exceeds a predetermined threshold of 70.

In an embodiment, when the AI model comprises the deep neural networks based AI model, the deep neural networks based AI model may include an input layer, one or more hidden layers, and an output layer. The input layer may be configured to receive the one or more features and the one or more derived features. The one or more hidden layers may include at least one of: one or more fully connected layers, one or more dropout layers, and one or more batch normalization layers. Each of the one or more fully connected layers may be configured to apply an activation function to transform input values. The activation function may include at least one of: a rectified linear unit (ReLU) function, a leaky ReLU function, a hyperbolic tangent (tanh) function, and a sigmoid function. The output layer may be configured to generate a probability value indicating a likelihood that the one or more second users are qualified to obtain the one or more credits. In another embodiment, when the AI model comprises the decision trees based AI model, the decision trees based AI model may include a root node, one or more internal nodes, and one or more leaf nodes. The root node may be configured to evaluate a primary feature of the one or more features. Each of the one or more internal nodes may be configured to evaluate a respective feature of the one or more features based on a split criterion. The split criterion may include at least one of: a Gini impurity criterion, an entropy criterion, and a variance reduction criterion. Each of the one or more leaf nodes may be configured to provide a qualification outcome indicating whether the one or more second users are qualified to obtain the one or more credits.

In yet another embodiment, when the AI model comprises the random forest based AI model, the random forest based AI model may include a plurality of decision trees. Each of the plurality of decision trees may be trained on a bootstrap sample of historical qualification data. The random forest based AI model may be configured to aggregate qualification outcomes from the plurality of decision trees using at least one of: a majority voting mechanism and an averaging mechanism. The random forest based AI model may be configured to generate a final qualification outcome based on the aggregated qualification outcomes. In yet another embodiment, when the AI model comprises the logistic regression based AI model, the logistic regression based AI model may be configured to calculate a log-odds value based on the one or more features and the one or more derived features. The logistic regression based AI model may be configured to apply a logistic function to the log-odds value to generate a probability value. The probability value may indicate a likelihood that the one or more second users 108 are qualified to obtain the one or more credits.

In an aspect, during the decision stage, the AI model may be configured to compare the qualification score or the probability value with one or more threshold values. The one or more threshold values may include at least one of: a full approval threshold, a partial approval threshold, and a denial threshold. The AI model may be configured to determine that the one or more second users 108 are fully qualified to obtain the one or more credits when the qualification score or the probability value exceeds the full approval threshold. The AI model may be configured to determine that the one or more second users 108 are partially qualified to obtain a partial loan amount when the qualification score or the probability value is between the partial approval threshold and the full approval threshold. The AI model may be configured to determine that the one or more second users 108 are not qualified to obtain the one or more credits when the qualification score or the probability value is below the denial threshold. In some aspects, the AI model may be configured to generate one or more explanation outputs associated with the qualification determination. The one or more explanation outputs may include at least one of: one or more factors contributing to the qualification determination, one or more feature importance values, and one or more recommendations for improving qualification status of the one or more second users 108.

The plurality of subsystem 112 further includes the training subsystem 228 that is communicatively connected to the one or more hardware processors 204. The training subsystem 228 is configured to train the AI model through a multi-stage training process. The multi-stage training process initially involves obtaining historical qualification data from one or more data sources. The historical qualification data may include at least one of: historical second data, historical qualification outcomes, historical loan performance data, and historical repayment data, associated with the one or more previous second users. The multi-stage training process may refer to a process of training the AI model through multiple sequential stages to learn patterns from historical data for determining qualification of the one or more second users. The historical qualification data may refer to previously collected data used to train the AI model, obtained from one or more data sources such as loan application databases, credit bureau databases, and financial institution databases. The historical second data may refer to previously collected information associated with the one or more previous second users, including at least one of: name, phone number, address, social security number, birth date, and annual income. The historical qualification outcomes may refer to previously determined results indicating whether the one or more previous second users were qualified or not qualified to obtain credits. The historical loan performance data may refer to previously collected information indicating how loans performed over time, including at least one of: on-time payments, late payments, and default status. The historical repayment data may refer to previously collected information indicating repayment behavior of the one or more previous second users, including at least one of: payment amounts, payment dates, and remaining balances.

For example, the AI model may obtain historical qualification data comprising 100,000 records from a loan application database, wherein each record includes historical second data such as an annual income of $55,000 and a birth date of January 1985, a historical qualification outcome indicating the previous second user was qualified, historical loan performance data indicating 36 on-time payments out of 36 total payments, and historical repayment data indicating a remaining balance of $0, and the AI model may use this historical qualification data to learn patterns for determining whether new second users are qualified to obtain credits.

The multi-stage training process further involves pre-processing the historical qualification data to generate pre-processed training data. Pre-processing may refer to a process of preparing and cleaning the historical qualification data before using it to train the AI model. The pre-processed training data may refer to the historical qualification data that has been cleaned, formatted, and transformed into a suitable format for training the AI model. Pre-processing the historical qualification data may include at least one of: removing duplicate data records, identifying and removing outlier data records, normalizing data to a standardized format, handling missing data fields, and validating data against pre-defined formats and ranges. Normalizing data may include transforming data values to a common scale using at least one of min-max normalization, z-score normalization, and decimal scaling normalization.

Handling missing data fields may include at least one of: removing records with missing data, imputing missing values with mean values, imputing missing values with median values, and imputing missing values using a k-nearest neighbors imputation method. Removing outlier data records may include identifying data records that deviate significantly from normal patterns using at least one of: a z-score method, an interquartile range method, and a density-based method. For example, the AI model may receive historical qualification data comprising 100,000 records, remove 500 duplicate records, identify and remove 1,000 outlier records with annual incomes exceeding $10,000,000, normalize annual income values to a range of 0 to 1 using min-max normalization, impute 2,000 missing birth date values with median values, and generate pre-processed training data comprising 98,500 cleaned and formatted records ready for training the AI model.

The multi-stage training process further involves extracting one or more training features from the pre-processed training data. Extracting may refer to a process of identifying and deriving meaningful characteristics from the pre-processed training data that are relevant for determining qualification of the one or more second users. The one or more training features may refer to measurable attributes derived from the pre-processed training data that the AI model uses to learn patterns for qualification determination. The one or more training features may correspond to the one or more features used during the qualification determination process and may include at least one of: a debt-to-income ratio, a credit utilization ratio, a payment history pattern, an employment stability indicator, a residential stability indicator, and an income verification indicator.

Extracting the one or more training features may further include generating one or more derived training features by combining multiple training features, wherein the one or more derived training features may include at least one of: a financial stability score, a risk exposure indicator, and a repayment capacity indicator. Extracting the one or more training features may also include performing feature selection to identify the most relevant training features using at least one of: correlation-based feature selection, chi-square feature selection, mutual information feature selection, forward selection method, backward elimination method, and recursive feature elimination method. For example, the AI model may extract training features from pre-processed training data by calculating a debt-to-income ratio of 25% from an annual income of $60,000 and monthly debt payments of $1,250, calculating a credit utilization ratio of 35% from a credit limit of $10,000 and a current balance of $3,500, deriving an employment stability indicator of 0.9 from 5 years of continuous employment, generating a financial stability score of 78 by combining the debt-to-income ratio and employment stability indicator, and transforming the extracted training features into a feature vector representation for training the AI model.

The multi-stage training process further involves configuring one or more hyperparameters for the AI model. The one or more hyperparameters include at least one of: a learning rate, a batch size, a number of epochs, a number of hidden layers, a number of nodes in each hidden layer, a dropout rate, a regularization strength, a momentum value, and a decay rate. Configuring may refer to a process of setting and adjusting parameters that control how the AI model learns from the training data. The one or more hyperparameters may refer to configuration settings that are set before training begins and control the learning behavior of the AI model. The learning rate may refer to a value that controls how much the AI model adjusts its weights in response to errors during each training iteration, wherein a higher learning rate results in faster but potentially less accurate learning. The batch size may refer to a number of training data records processed together before the AI model updates its weights.

The number of epochs may refer to a count of complete passes through the entire training data during the training process. The number of hidden layers may refer to a count of intermediate processing layers between the input layer and output layer of the AI model. The number of nodes in each hidden layer may refer to a count of processing units within each hidden layer that perform calculations. The dropout rate may refer to a probability of randomly disabling nodes during training to prevent overfitting. The regularization strength may refer to a value that controls a penalty applied to large weights to prevent overfitting. The momentum value may refer to a value that accelerates learning by considering previous weight updates when calculating current updates. The decay rate may refer to a value that gradually reduces the learning rate over time during training. For example, the AI model may be configured with a learning rate of 0.001, a batch size of 64, a number of epochs of 100, a number of hidden layers of 3, a number of nodes of 128 in each hidden layer, a dropout rate of 0.2, a regularization strength of 0.0001, a momentum value of 0.9, and a decay rate of 0.001.

The multi-stage training process further involves training the AI model based on at least one of: the one or more training features, the historical qualification outcomes, and the one or more hyperparameters, to learn the one or more weights associated with the one or more training features. Training may refer to a process of teaching the AI model to recognize patterns in the training data by iteratively adjusting internal parameters based on the one or more training features and the historical qualification outcomes. The one or more weights may refer to numerical values that represent the importance of each training feature in determining qualification outcomes, wherein the AI model learns these weights during the training process. Learning the one or more weights may involve the AI model processing the one or more training features, generating predicted qualification outcomes, comparing the predicted qualification outcomes with the historical qualification outcomes, computing errors between the predicted and historical outcomes, and adjusting the one or more weights to minimize the errors.

The training process may use the one or more hyperparameters to control how the AI model learns, including the learning rate to control weight adjustment magnitude, the batch size to control how many records are processed before updating weights, and the number of epochs to control how many times the AI model processes the entire training data. The AI model may learn the one or more weights by minimizing a loss function that measures the difference between predicted qualification outcomes and historical qualification outcomes using optimization algorithms such as stochastic gradient descent, Adam optimization, or RMSprop optimization. For example, the AI model may receive training features including a debt-to-income ratio of 25% and a credit utilization ratio of 35% with a historical qualification outcome of qualified, initially assign random weights of 0.5 to each feature, predict a qualification outcome of not qualified, compute an error between the predicted and historical outcomes, adjust the weights to 0.4 for debt-to-income ratio and 0.3 for credit utilization ratio based on the learning rate of 0.001, and repeat this process for 100 epochs until the AI model learns optimal weights that accurately predict qualification outcomes.

The multi-stage training process further involves validating performance of the trained AI model using validation data. Validating may refer to a process of evaluating how well the trained AI model performs on data that was not used during training. The performance of the trained AI model may refer to how accurately the trained AI model predicts qualification outcomes for the one or more second users. The validation data may refer to a subset of the historical qualification data that is set aside and not used during training, but is used to test the trained AI model. For example, the AI model may be trained using 80,000 training records and validated using 20,000 validation records, wherein the trained AI model correctly predicts qualification outcomes for 18,500 of the 20,000 validation records, resulting in an accuracy of 92.5%, and the AI model may be deployed for determining qualification of the one or more second users when the accuracy exceeds a predetermined threshold of 90%.

The multi-stage training process further involves deploying the trained AI model for determining whether the one or more second users are qualified to obtain the one or more credits associated with the one or more projects. Deploying may refer to a process of making the trained AI model available and operational on the one or more hardware processors for real-time qualification determination. Deploying the trained AI model may include storing the trained AI model with its learned weights in the memory coupled to the one or more hardware processors, configuring the trained AI model to receive the one or more second data from the one or more second electronic devices, and enabling the trained AI model to generate qualification determinations for the one or more second users. For example, the trained AI model with learned weights may be deployed to a cloud server, wherein the deployed AI model receives second data from a second user including an annual income of $65,000 and a debt-to-income ratio of 28%, processes the second data using the learned weights, and determines within 2 seconds that the second user is qualified to obtain credits for a home improvement project.

In an embodiment, for validating the performance of the trained AI model using the validation data, the training subsystem 228 is initially configured to split the historical qualification data into training data and the validation data. Splitting may refer to a process of dividing the historical qualification data into two separate portions, wherein one portion is used for training the AI model and another portion is used for validating performance of the trained AI model. The training data may refer to a first portion of the historical qualification data used to teach the AI model to learn patterns and weights for qualification determination. The validation data may refer to a second portion of the historical qualification data that is not used during training but is used to evaluate how well the trained AI model performs on unseen data. For example, the AI model may split 100,000 historical qualification records using an 80-20 split, wherein 80,000 records are used as training data to train the AI model and 20,000 records are used as validation data to validate performance of the trained AI model.

The training subsystem 228 is further configured to determine one or more performance metrics based on the validation data. The one or more performance metrics comprise at least one of: an accuracy metric, a precision metric, a recall metric, an F1 score metric, an area under the receiver operating characteristic curve metric, and an area under the precision-recall curve metric. The one or more performance metrics may refer to numerical measurements used to evaluate how well the trained AI model predicts qualification outcomes based on the validation data. The accuracy metric may refer to a percentage of correct qualification predictions out of total predictions made by the trained AI model. The precision metric may refer to a percentage of correct positive qualification predictions out of all positive predictions made by the trained AI model. The recall metric may refer to a percentage of correct positive qualification predictions out of all actual positive qualification outcomes in the validation data. The F1 score metric may refer to a harmonic mean of the precision metric and the recall metric, providing a balanced measure of the trained AI model performance. The area under the receiver operating characteristic curve metric may refer to a measurement of the trained AI model ability to distinguish between qualified and not qualified second users across different threshold values. The area under the precision-recall curve metric may refer to a measurement of the trained AI model performance when dealing with imbalanced qualification outcomes. For example, the trained AI model may be evaluated using 20,000 validation records containing 15,000 qualified and 5,000 not qualified outcomes, wherein the trained AI model correctly predicts 14,250 qualified and 4,500 not qualified outcomes, resulting in an accuracy metric of 93.75%, a precision metric of 96.6%, a recall metric of 95%, an F1 score metric of 95.8%, an area under the receiver operating characteristic curve metric of 0.94, and an area under the precision-recall curve metric of 0.97.

The training subsystem 228 is further configured to perform hyperparameter tuning to adjust the one or more hyperparameters of the AI model based on the one or more performance metrics. The hyperparameter tuning may refer to a process of systematically adjusting the one or more hyperparameters of the AI model to improve the one or more performance metrics. Adjusting the one or more hyperparameters may include modifying values of the learning rate, batch size, number of epochs, number of hidden layers, number of nodes in each hidden layer, dropout rate, regularization strength, momentum value, and decay rate based on the one or more performance metrics calculated using the validation data. The hyperparameter tuning may be performed using at least one of: a grid search method that evaluates all possible combinations of hyperparameter values, a random search method that evaluates randomly selected combinations of hyperparameter values, and a Bayesian optimization method that uses probabilistic models to select promising hyperparameter combinations. For example, the AI model may initially be configured with a learning rate of 0.01 resulting in an accuracy metric of 85%, and hyperparameter tuning may adjust the learning rate to 0.001, the dropout rate from 0.3 to 0.2, and the number of hidden layers from 2 to 3, resulting in an improved accuracy metric of 93%.

The training subsystem 228 is further configured to retrain the AI model periodically based on updated historical qualification data. The retraining of the AI model is triggered based on at least one of: a predetermined time interval, a predetermined number of new qualification determinations, and a detected decrease in the one or more performance metrics. Retraining may refer to a process of updating the trained AI model by training it again using updated historical qualification data to maintain or improve its performance over time. Periodically may refer to retraining the AI model at regular intervals or when specific conditions are met. The updated historical qualification data may refer to the historical qualification data that includes new qualification determinations, new loan performance data, and new repayment data collected after the initial training of the AI model.

The predetermined time interval may refer to a fixed schedule for retraining the AI model, such as daily, weekly, monthly, or quarterly. The predetermined number of new qualification determinations may refer to a threshold count of new qualification decisions made by the AI model that triggers retraining when reached. The detected decrease in the one or more performance metrics may refer to a situation where the accuracy, precision, recall, F1 score, or other performance metrics of the trained AI model fall below acceptable levels, indicating that the AI model needs to be retrained to improve its performance. For example, the AI model may be initially trained with 100,000 historical qualification records and deployed for qualification determination, and the AI model may be retrained when a predetermined time interval of one month has passed, or when a predetermined number of 10,000 new qualification determinations have been made, or when a detected decrease in accuracy metric from 93% to 88% is observed, wherein the retraining incorporates the new qualification data to update the learned weights and restore the accuracy metric to 94%.

If the one or more second users 108 are qualified, then the qualification determining subsystem 216 may terminate the application and may decline an adverse action notice (AAN) to the one or more second electronic devices 110 of the one or more second users 108. The qualification determining subsystem 216 is further configured to determine whether the one or more second users 108 are approved for a partial loan amount. The qualification determining subsystem 216 is configured to show a partial AAN along with an option to one or more third users (e.g., one or more co-applicants). If the one or more second users 108 declines to add the one or more third users within a predetermined time period (e.g., one month), the qualification determining subsystem 216 may terminate the application and may decline an adverse action notice (AAN) to the one or more second electronic devices 110 of the one or more second users 108.

The plurality of subsystems 112 includes the user addition subsystem 220 that is communicatively connected to the one or more hardware processors 204. If the one or more second users 108 want to add the one or more third users, the user addition subsystem 220 is configured to provide options (e.g., one or more second options) to the one or more second electronic devices 110 of the one or more second users 108 to add the one or more third users. The one or more second options may refer to options provided to the one or more second electronic devices 110 of the one or more second users 108 to add the one or more third users as co-applicants to the one or more financial applications. The one or more third users may be added when the one or more second users 108 are approved for a partial loan amount or when the one or more second users 108 wish to include additional applicants to improve qualification for the one or more credits. For example, the user addition subsystem 220 may provide one or more second options to the one or more second electronic devices 110 of the one or more second users 108 displaying an option to add a spouse as a co-applicant when the one or more second users 108 are approved for a partial loan amount of $15,000 instead of the requested $25,000. The one or more second users 108 may select the option to add the spouse as the one or more third users. The user addition subsystem 220 is configured to obtain one or more fourth data associated with the one or more third users from at least one of: the one or more second electronic devices 110 of the one or more second users 108 and one or more third electronic devices of the one or more third users. In an embodiment, the one or more fourth data associated with the one or more third users may include at least one of: the name, the phone number, the address, the at least last four digits of a social security number (SSN), the birth date, and the annual income, of the one or more third users.

In an embodiment, the user addition subsystem 220 is configured to repeat the process until the one or more third users are added. In an embodiment, the user addition subsystem 220 is further configured to terminate the application when the one or more second electronic devices 110 of the one or more second users 108 decide not to proceed with the partial amount and the one or more second electronic devices 110 of the one or more second users 108 are unable to add the one or more third electronic devices of the one or more third users. The qualification determining subsystem 216 is further configured to determine whether the one or more second users 108 are approved for a full loan amount or the partial loan amount. The risk-based price determining subsystem 212 is further configured to send the one or more first risk-based pricing options associated with the one or more projects, to the one or more second electronic devices 110 of the one or more second users 108.

The risk-based price determining subsystem 212 is further configured to determine whether the one or more second users 108 accept the one or more first risk-based pricing options associated with the one or more projects. The risk-based price determining subsystem 212 is further configured to determine the one or more second risk-based pricing options associated with the one or more projects to be sent to the one or more second electronic devices 110 of the one or more second users 108 when the one or more second users 108 reject the one or more first risk-based pricing options associated with the one or more projects. The one or more second risk-based pricing options may refer to alternative loan offers associated with the one or more projects that are determined and sent to the one or more second electronic devices 110 of the one or more second users 108 when the one or more second users 108 reject the one or more first risk-based pricing options. The one or more second risk-based pricing options may include buydown loan offers with different interest rates, repayment terms, or loan amounts compared to the one or more first risk-based pricing options. The risk-based price determining subsystem 212 is further configured to determine one or more subsequent risk-based pricing options associated with the one or more projects and to send the one or more subsequent risk-based pricing options to the one or more second electronic devices 110 of the one or more second users 108.

If the one or more second electronic devices 110 of the one or more second users 108 do not select the one or more risk-based pricing options associated with the one or more projects, the application may display the AAN to the one or more second electronic devices 110 of the one or more second users 108 and the process may be terminated. In the meantime, one or more reminder messages are sent to at least one of: the one or more second electronic devices 110 of the one or more second users 108 and the one or more first electronic devices 106 of the one or more first users 104, to complete the application.

When the one or more second electronic devices 110 of the one or more second users 108 accept the one or more risk-based pricing options (e.g., one or more loan offers), the one or more second users 108 are directed to a registration screen of the application where the one or more second users 108 create log in identity and password to enter into the application. At this stage, the one or more second users 108 are able to proceed once the one or more first users 104 enter all the information associated with the one or more projects. When the information is not available then the data transmission subsystem 214 is configured to send a message to the one or more first users 104.

Further, the data obtaining subsystem 210 is configured to obtain the one or more confirmed information associated with the one or more projects, from the one or more second electronic devices 110 of the one or more second users 108. The one or more confirmed information associated with the one or more projects may include at least one of: one or more names associated with the one or more first users 104, one or more categories of works associated with the one or more projects, estimation of the works associated with the one or more projects, the time duration of the one or more projects, information associated with one or more ownerships, one or more categories of one or more properties of the one or more second users 108. The information associated with one or more ownerships may be at least one of: owner occupied, joint owners, rental, vacation home, and the like. The one or more categories of one or more properties of the one or more second users 108 may include at least one of: single family, apartment, condo/town house, and the like.

The data transmission subsystem 214 is configured to send a notification message to the one or more first electronic devices 106 of the one or more first users 104 when the one or more second users 108 submit the one or more confirmed information associated with the one or more projects. The data obtaining subsystem 210 is further configured to obtain the one or more third data associated with the one or more identities of the one or more second users 108 to map the one or more second data with the one or more third data. For example, the one or more second electronic devices 110 are adapted to take a picture of government-issued photo id of the one or more second users 108, which is uploaded and verified against the one or more second data obtained earlier. In an embodiment, the data obtaining subsystem 210 must obtain both sides of the identity of the one or more second users 108 for identifying name and address. Further, the one or more electronic devices 110 are adapted to take a selfie photograph of the one or more second users 108. The one or more second electronic devices 110 are adapted to take a liveliness check with blinking of eyes of the one or more second users 108. The application is terminated with the AAN when the results are not matched.

In some aspects, the AI-based system 102 may be configured to capture one or more images of the one or more identities of the one or more second users 108 using one or more camera sensors of the one or more second electronic devices 110. The AI-based system 102 may further be configured to configured to perform ID classification (using a data classifying subsystem that is not shown in FIG. 2) and detection on-device using a custom machine learning model. The custom machine learning model may be built using transfer learning based on a YOLOv8 architecture and trained on a custom ID card image catalog. The custom machine learning model may be deployed as a CoreML model on iOS devices and a TensorFlow Lite (TFLite) model on Android devices.

In some aspects, the custom machine learning model may be configured to distinguish a real ID card from look-alike documents such as credit cards and membership cards. The custom machine learning model may be further configured to classify an ID type and a state associated with the ID card. The custom machine learning model may output at least one of: bounding boxes, confidence scores, and classifications for detected regions including at least one of: ID region, license text region, state label region, face region, PDF417 barcode region, and non-ID label region.

In some aspects, the AI-based system 102 may be configured to process camera frames from the one or more second electronic devices 110 through an ID card processing pipeline. The ID card processing pipeline may comprise at least one of: early reject gates, geometry and crop normalization, on-device model inference, and quality scoring with best-frame selection. The early reject gates may include at least one of: a motion check and basic frame quality checks performed before heavy processing. The motion check may reject frames when a motion magnitude exceeds a predetermined motion threshold. The basic frame quality checks may reject frames when an average brightness is below a minimum brightness threshold or above a maximum brightness threshold, or when a variance is below a minimum variance threshold.

The geometry and crop normalization may comprise at least one of: finding a card rectangle in the frame, validating the card rectangle, performing perspective correction, and cropping to a standard size. The card rectangle may be validated based on an aspect ratio within a predetermined tolerance range. The cropped image may be normalized to a standard resolution for processing by the custom machine learning model. The quality scoring may comprise evaluating at least one of: blur variance, motion blur ratio, glare level, and contrast level. The best-frame selection may comprise buffering successful frames and selecting a best frame based on a total quality score and a lighting confidence score.

In some aspects, the AI-based system 102 with a data extracting subsystem (not shown in FIG. 2) may be configured to extract an ID template from the cropped ID image. The ID template may be represented as a vector that represents an ID footprint of the government-issued identification document. The AI-based system 102 with the data extracting subsystem may be configured to verify the one or more identities of the one or more second users by submitting the ID template vector to a third-party DMV-integrated security service for server-side validation. In some aspects, the third-party DMV-integrated security service may be configured to confirm authenticity of the government-issued identification document and to detect replay attacks and deepfake-style attacks based on template and consistency checks. A response from the third-party DMV-integrated security service may feed into gating logic as a verification result and a risk/security level.

In some aspects, the liveness check may run locally on-device without requiring a server roundtrip for a core liveness decision. The liveness check may be configured to verify that the one or more second users 108 are physically present during the biometric verification. In some aspects, the AI-based system 102 with the data extracting subsystem may be configured to perform biometric extraction using a FaceNet embedding model. The FaceNet embedding model may be configured to generate/extract a biometric vector from a face image captured from the one or more second users 108. The biometric vector may be used in combination with ID template signals and a device blueprint score to produce a combined security level. The FaceNet embedding model may be configured to map the face image to a compact numerical representation in a high-dimensional vector space. The biometric vector may encode unique facial features of the one or more second users 108 that can be used for identity verification and matching. The biometric vector may be compared with a facial template extracted from the government-issued photo id to verify that the one or more second users 108 match the identity on the government-issued photo id.

In an embodiment, the liveness check may run locally on the one or more second electronic devices 110 of the one or more second users 108. The liveness check may be executed on-device without requiring a server roundtrip for a core liveness decision. The on-device execution of the liveness check may reduce latency, improve user experience, and enhance privacy by keeping biometric data local to the one or more second electronic devices 110. The liveness check may be configured to verify that the one or more second users 108 are physically present during the identity verification process and are not using a photograph, video, mask, or other spoofing technique to fraudulently verify identity.

In an embodiment, the on-device identity and biometric security pipeline may be implemented on multiple app platforms including iOS and Android. The iOS platform and the Android platform may execute the same logical pipeline for identity verification and biometric security. The Android platform may utilize Google ML Kit for performing on-device machine learning tasks where appropriate, including at least one of: face detection, barcode scanning, and text recognition. The iOS platform may utilize CoreML for performing on-device machine learning tasks. The custom machine learning model for ID classification and detection may be deployed as a CoreML model on the iOS platform and as a TensorFlow Lite (TFLite) model on the Android platform, wherein both deployments use the same labels and the same inference intent.

In another embodiment, the on-device identity and biometric security pipeline may be configured to verify identities of users associated with different user roles. The user roles may include at least one of: a provider role, a borrower role, and a co-borrower role. The provider role may correspond to the one or more first users 104 who initiate and manage the one or more projects. The borrower role may correspond to the one or more second users 108 who seek financial assistance for the one or more projects. The co-borrower role may correspond to the one or more third users who are added as co-applicants to the one or more financial applications. The on-device identity and biometric security pipeline may perform identity verification and biometric security checks for users in the borrower role and the co-borrower role during onboarding.

In yet another embodiment, the on-device identity and biometric security pipeline may run during onboarding of the one or more second users 108 and the one or more third users. The on-device identity and biometric security pipeline may be executed before submission of the one or more financial applications and before funding of the one or more credits. The on-device identity and biometric security pipeline may serve as a security checkpoint that must be successfully completed before the one or more second users 108 and the one or more third users are allowed to proceed with the financial application process. The security checkpoint may be configured to verify identity, confirm liveness, assess device trustworthiness, and evaluate customer confidence before allowing the one or more second users 108 and the one or more third users to submit the one or more financial applications for funding.

In some aspects, the AI-based system 102 with a data generating subsystem (not shown in FIG. 2) may be configured to generate a device blueprint by extracting device-specific features from the one or more second electronic devices 110. The device blueprint may be used to generate a device confidence score indicating trustworthiness of the one or more second electronic devices 110. The AI-based system 102 may be configured to run a customer confidence machine learning model over a combination of features. The combination of features may comprise at least one of: device features, transactional features, financial features, social features, and behavioral features. The customer confidence machine learning model may output a score or risk level indicating confidence in the identity and legitimacy of the one or more second users 108.

The AI-based system 102 with the data generating subsystem may be configured to generate the device blueprint for the one or more second electronic devices 110 of the one or more second users 108. The device blueprint may be generated by extracting device-specific features from the one or more second electronic devices 110. The device-specific features may comprise at least one of: a device identifier, a device model, an operating system version, a screen resolution, an IP address, a geolocation, a time zone, a language setting, installed applications, battery status, network connection type, and device sensor data. The AI-based system 102 may be configured to turn the device-specific features into the device confidence score. The device confidence score may indicate the trustworthiness level of the one or more second electronic devices 110. A higher device confidence score may indicate that the one or more second electronic devices 110 are likely legitimate devices associated with the one or more second users 108. A lower device confidence score may indicate that the one or more second electronic devices 110 may be compromised, emulated, or associated with fraudulent activity.

The AI-based system 102 with the data generating subsystem may be configured to run a customer confidence machine learning (ML) model to evaluate the one or more second users 108. The customer confidence ML model may be trained on a combination of features comprising at least one of: transactional features, device features, financial features, social features, and behavioral features. The transactional features may comprise at least one of: transaction history, transaction frequency, transaction amounts, and transaction patterns of the one or more second users 108. The device features may comprise the device-specific features extracted from the one or more second electronic devices 110. The financial features may comprise at least one of: credit score, credit history, debt-to-income ratio, income level, and account balances of the one or more second users 108. The social features may comprise at least one of: social media presence, social connections, and online reputation of the one or more second users 108. The behavioral features may comprise at least one of: application usage patterns, navigation patterns, typing patterns, and interaction patterns of the one or more second users 108 with the one or more second electronic devices 110.

The customer confidence ML model may output a score or risk level indicating confidence in the identity and legitimacy of the one or more second users 108. The score may be a numerical value within a predetermined range indicating a confidence level. The risk level may be a categorical value indicating a risk category such as low risk, medium risk, or high risk. The score or risk level may be used in combination with other verification results to determine whether to proceed with the financial application process. In some aspects, the AI-based system 102 with a security level generating subsystem may be configured to generate a final security level or confidence score based on outputs from the ID verification, liveness check, biometric extraction, device blueprint, and customer confidence machine learning model. The AI-based system 102 may further be configured to gate the onboarding flow via a rule engine based on the final security level or confidence score. The rule engine may be configured to determine at least one of: a step-up action requiring additional verification, a reject action terminating the application, and a proceed action allowing the one or more second users 108 to continue with the onboarding process.

The AI-based system 102 may be configured to gate the onboarding flow and the financial application process via a rule engine. The rule engine may be configured to evaluate gates based on at least one of: model output from the customer confidence ML model and verification results from the identity verification process. The model output may comprise the score or risk level from the customer confidence ML model. The verification results may comprise at least one of: the liveness check result, the biometric matching result, the ID verification result, the template verification result from the third-party DMV-integrated security service, and the device confidence score from the device blueprint.

The rule engine may be configured to determine one or more actions based on evaluation of the gates. The one or more actions may comprise at least one of: a step-up action, an allow action, a deny action, and a require extra documents action. The step-up action may require the one or more second users 108 to perform additional verification steps such as answering security questions, providing additional identification documents, or completing a video verification call. The allow action may permit the one or more second users 108 to proceed with the financial application process without additional verification. The deny action may terminate the application and decline an adverse action notice (AAN) to the one or more second electronic devices 110 of the one or more second users 108. The require extra documents action may require the one or more second users 108 to provide additional documentation such as proof of income, proof of residence, or additional identification documents before proceeding with the financial application process. The rule engine may be configured to apply one or more rules to determine the one or more actions. The one or more rules may comprise at least one of: threshold rules, combination rules, and override rules. The threshold rules may compare the score or risk level from the customer confidence ML model against predetermined thresholds to determine the one or more actions. The combination rules may combine multiple verification results to determine the one or more actions. The override rules may override other rules based on specific conditions such as high-risk indicators or fraud alerts.

In some aspects, the AI-based system 102 with a data processing subsystem (not shown in FIG. 2) may be configured to process the government-issued photo id of the one or more second users 108 through an ID card processing pipeline executed on-device on the one or more second electronic devices 110. The ID card processing pipeline may comprise at least one of: a frame streaming and throttling stage, an early reject gates stage, a geometry and crop normalization stage, an on-device model inference stage, and a frame scoring and selection stage. During the frame streaming and throttling stage, camera frames may stream in from a camera sensor of the one or more second electronic devices 110. The AI-based system 102 with the data processing subsystem may be configured to throttle the camera frames so that multiple frames are not processed at the same time. The AI-based system 102 may be further configured to skip initial warmup frames before processing begins. The throttling and skipping of initial warmup frames may ensure stable and consistent frame quality for subsequent processing stages. During the early reject gates stage, the AI-based system 102 with the data processing subsystem may be configured to perform a motion check and basic frame quality checks before heavy processing work is performed. The motion check may be configured to detect excessive movement of the one or more second electronic devices 110 or the government-issued photo id during image capture. The basic frame quality checks may be configured to evaluate at least one of: brightness level, lighting variance, and image clarity. Frames that fail the motion check or the basic frame quality checks may be rejected early to conserve processing resources and improve overall pipeline efficiency.

During the geometry and crop normalization stage, the AI-based system 102 with the data processing subsystem may be configured to find a card rectangle within the camera frame corresponding to the government-issued photo id. The AI-based system 102 may be further configured to validate the card rectangle based on at least one of: aspect ratio, corner positions, and size relative to the frame. The AI-based system 102 with the data processing subsystem may be further configured to perform perspective correction on the card rectangle to correct for angular distortion caused by the camera angle. The AI-based system 102 may be further configured to crop the perspective-corrected card rectangle to a standard size for consistent processing by subsequent stages. During the on-device model inference stage, the AI-based system 102 with the data processing subsystem may be configured to run an on-device machine learning model derived from a YOLOv8 architecture. The on-device machine learning model may be configured to detect one or more regions within the cropped image, wherein the one or more regions comprise at least one of: a face region, an ID region, and a barcode region. The on-device machine learning model may be further configured to classify what type of card the government-issued photo id is, including at least one of: a driver's license, a state identification card, a passport, and a non-ID card such as a credit card or membership card. During the frame scoring and selection stage, the AI-based system 102 with the data processing subsystem may be configured to score frames based on at least one of: blur level, glare level, contrast level, and model confidence from the on-device machine learning model. The AI-based system 102 with the data processing subsystem may be configured to determine a total quality score for each frame based on the blur level, glare level, contrast level, and model confidence. The AI-based system 102 with the data processing subsystem may be further configured to pick a best frame having a highest total quality score before continuing with subsequent identity verification processes. The best frame may be used for ID template extraction, biometric matching, and third-party verification.

The AI-based system 102 with the data processing subsystem may be configured to perform early reject gates and normalization during the ID card processing pipeline. The early reject gates may comprise at least one of: a motion gate, a lighting gate, and a rectangle gate. The normalization may comprise a crop normalization process. The motion gate may be configured to detect excessive movement during image capture. The motion gate may convert camera frames to a grayscale resolution of 320×240 pixels. The motion gate may calculate a mean squared difference (MSD) between a current frame and a previous frame to determine a motion magnitude value. The motion gate may reject frames when the motion magnitude value exceeds a predetermined motion threshold. In an embodiment, the predetermined motion threshold may be 0.6. When the motion magnitude value exceeds the predetermined motion threshold, the AI-based system 102 may prompt the one or more second users 108 to hold the one or more second electronic devices 110 steady. the lighting gate may be configured to evaluate lighting conditions during image capture. The lighting gate may calculate an average brightness value for each frame. The lighting gate may reject frames when the average brightness value is below a minimum brightness threshold or above a maximum brightness threshold. In an embodiment, the minimum brightness threshold may be 30 and the maximum brightness threshold may be 240. The lighting gate may further calculate a variance value for each frame. The lighting gate may reject frames when the variance value is below a minimum variance threshold. In an embodiment, the minimum variance threshold may be 15.

The rectangle gate may be configured to validate a card rectangle detected within the camera frame. The rectangle gate may validate the card rectangle based on an aspect ratio of the card rectangle. In an embodiment, the aspect ratio may be 1.586 with a tolerance of plus or minus 15 percent. The rectangle gate may further validate that corners of the card rectangle are positioned inside a margin from edges of the frame. In an embodiment, the margin may be calculated as a maximum of 30 pixels or 3 percent of a minimum dimension of the frame. The crop normalization process may be configured to normalize the card rectangle to a standard size for consistent processing. The crop normalization process may add padding around the card rectangle before cropping. In an embodiment, the padding may be approximately 10 percent of the card rectangle dimensions. The crop normalization process may perform perspective correction on the padded card rectangle to correct for angular distortion. The crop normalization process may normalize the perspective-corrected image to a standard resolution. In an embodiment, the standard resolution may be 1114×702 pixels for landscape orientation or 702×1114 pixels for vertical orientation. The crop normalization process may apply an unsharp mask to the normalized image only when a blur variance value meets or exceeds a predetermined blur variance threshold. In an embodiment, the predetermined blur variance threshold may be 400.

In an embodiment, the AI-based system 102 with the data processing subsystem may be configured to execute an on-device machine learning model for ID card detection and classification on the one or more second electronic devices 110. The on-device machine learning model may be based on a YOLOv8 backbone architecture with transfer learning applied on a custom ID-card image catalog. The custom ID-card image catalog may comprise a plurality of images of government-issued identification documents used to train the on-device machine learning model to recognize and classify various types of ID cards. The on-device machine learning model may be deployed as a CoreML model on iOS devices and as a TensorFlow Lite (TFLite) model on Android devices. The CoreML model and the TFLite model may use the same labels and the same inference intent to ensure consistent ID card detection and classification across different mobile platforms. The deployment of the on-device machine learning model on both iOS and Android platforms may enable the AI-based system 102 to perform ID card verification for the one or more second users 108 regardless of the type of mobile device used. The on-device machine learning model may receive a normalized crop of the government-issued photo id as input. The normalized crop may be resized to a resolution of 640×640 pixels before being processed by the on-device machine learning model. The on-device machine learning model may apply non-maximum suppression (NMS) with a threshold of 0.3 to filter overlapping bounding boxes and retain only the most confident detections.

The on-device machine learning model may be configured as a multi-head single model that detects and classifies multiple regions within the government-issued photo id. The on-device machine learning model may use a plurality of labels comprising at least one of: an id label, a license text label, a state label, a face label, a pdf417 barcode label, and a non-id label. The id label may indicate a detected ID card region. The license text label may indicate a detected region containing license text information. The state label may indicate a detected region containing state identification information. The face label may indicate a detected face region on the ID card. The pdf417 barcode label may indicate a detected PDF417 barcode region commonly found on driver's licenses and identification cards. The non-id label may indicate a detected region that is not an ID card, such as a credit card or membership card.

The on-device machine learning model may output at least one of: bounding boxes, confidence scores, and classifications for each detected region. The bounding boxes may define coordinates of detected regions within the normalized crop. The confidence scores may indicate a probability that each detected region corresponds to its assigned label. The classifications may indicate at least one of: a state associated with the ID card, an ID type of the ID card, and whether the detected document is an ID card or a non-ID card. The classifications may enable the AI-based system 102 to distinguish a real government-issued identification document from look-alike documents such as credit cards and membership cards. The AI-based system 102 with the data processing subsystem may be configured to perform quality scoring and best-frame selection during the ID card processing pipeline. The quality scoring may evaluate each captured frame based on a plurality of quality metrics. The best-frame selection may select an optimal frame for subsequent identity verification processes based on success criteria and buffering rules.

The plurality of quality metrics may comprise at least one of: a blur variance metric, a motion blur ratio metric, a glare metric, and a contrast metric. The blur variance metric may measure sharpness of the captured frame, wherein a higher blur variance value indicates a sharper image. A frame may satisfy the blur variance metric when the blur variance value is greater than or equal to a predetermined blur variance threshold. In an embodiment, the predetermined blur variance threshold may be 400. The motion blur ratio metric may measure motion blur present in the captured frame, wherein a lower motion blur ratio value indicates less motion blur. A frame may satisfy the motion blur ratio metric when the motion blur ratio value is less than a predetermined motion blur ratio threshold. In an embodiment, the predetermined motion blur ratio threshold may be 0.4. The glare metric may measure glare or reflection present in the captured frame, wherein a lower glare value indicates less glare. A frame may satisfy the glare metric when the glare value is less than or equal to a predetermined glare threshold. In an embodiment, the predetermined glare threshold may be 0.45. The contrast metric may measure contrast level of the captured frame, wherein a higher contrast value indicates better contrast. A frame may satisfy the contrast metric when the contrast value is greater than or equal to a predetermined contrast threshold. In an embodiment, the predetermined contrast threshold may be 0.15.

The AI-based system 102 with the data processing subsystem may be configured to determine whether a captured frame is a successful frame based on success criteria. The success criteria may comprise a total score requirement and a lighting confidence requirement. The total score may be calculated based on the plurality of quality metrics. A frame may satisfy the total score requirement when the total score is greater than or equal to a predetermined total score threshold. In an embodiment, the predetermined total score threshold may be 90. The lighting confidence may measure confidence in lighting conditions of the captured frame. A frame may satisfy the lighting confidence requirement when the lighting confidence value is greater than or equal to a predetermined lighting confidence threshold. In an embodiment, the predetermined lighting confidence threshold may be 6.5. A captured frame may be determined to be a successful frame when the total score is greater than or equal to the predetermined total score threshold AND the lighting confidence value is greater than or equal to the predetermined lighting confidence threshold.

The AI-based system 102 may be configured to buffer successful frames during the ID card processing pipeline. The AI-based system 102 may keep up to a maximum number of successful frames in a buffer. In an embodiment, the maximum number of successful frames may be 10. The AI-based system 102 may be configured to return a best frame from the buffer based on one or more return conditions. The one or more return conditions may comprise at least one of: a minimum frame count condition, a best score condition, and a timeout condition. The minimum frame count condition may be satisfied when the buffer contains at least a minimum number of successful frames. In an embodiment, the minimum number of successful frames may be 3. The best score condition may be satisfied when a best score among the buffered successful frames is greater than or equal to a predetermined best score threshold. In an embodiment, the predetermined best score threshold may be 97. The timeout condition may be satisfied when a predetermined timeout duration has elapsed since the start of frame capture. In an embodiment, the predetermined timeout duration may be 5 seconds. The AI-based system 102 may return the best frame from the buffer when at least one of the one or more return conditions is satisfied.

In some aspects, the AI-based system 102 with a template data generating subsystem (not shown in FIG. 2) may be configured to generate an ID template from the cropped ID image of the government-issued photo id of the one or more second users 108. The ID template may be represented as a vector that represents an ID footprint of the government-issued photo id. The ID footprint may comprise unique characteristics and features extracted from the government-issued photo id that can be used to verify authenticity and identity. The AI-based system 102 with the template data generating subsystem may be configured to extract one or more features from the cropped ID image to generate the template vector. The one or more features may comprise at least one of: facial features from a photo region, text features from text regions, barcode data from a PDF417 barcode region, document layout features, security feature patterns, and microprint patterns. The template vector may encode the one or more features in a numerical representation suitable for comparison and verification.

The AI-based system 102 with the template data generating subsystem may be configured to submit the template vector to the third-party DMV-integrated security service for server-side validation. The AI-based system 102 may further submit any extracted fields from the government-issued photo id along with the template vector. The extracted fields may comprise at least one of: name, address, date of birth, license number, expiration date, and issue date. The AI-based system 102 may further submit barcode data extracted from the PDF417 barcode region along with the template vector. The third-party DMV-integrated security service may be configured to validate the template vector and the extracted fields against official DMV records to confirm authenticity of the government-issued photo id. The AI-based system 102 with the template data generating subsystem may be configured to use a response from the third-party DMV-integrated security service to confirm authenticity of the government-issued photo id. The response may indicate whether the government-issued photo id is authentic based on comparison with official DMV records. The AI-based system 102 with the template data generating subsystem may further use the response to catch replay attacks and deepfake-style attacks. Replay attacks may comprise attempts to use a previously captured image or video of a government-issued photo id to fraudulently verify identity. Deepfake-style attacks may comprise attempts to use artificially generated or manipulated images of a government-issued photo id to fraudulently verify identity. The third-party DMV-integrated security service may perform template checks and consistency checks to detect replay attacks and deepfake-style attacks. The template checks may compare the template vector against known fraudulent templates. The consistency checks may verify that the extracted fields are consistent with each other and with official DMV records.

In an embodiment, the response from the third-party DMV-integrated security service may feed into gating logic of the AI-based system 102. The gating logic may use the response as a verification result and a risk/security level. The verification result may indicate whether the government-issued photo id has been successfully verified as authentic. The risk/security level may indicate a level of confidence in the authenticity of the government-issued photo id and the identity of the one or more second users 108. The gating logic may be configured to determine at least one of: a proceed action allowing the one or more second users 108 to continue with the financial application process when the verification result is positive and the risk/security level is acceptable, a step-up action requiring additional verification when the verification result is inconclusive or the risk/security level is elevated, and a reject action terminating the application when the verification result is negative or the risk/security level is unacceptable. The application may be terminated with the AAN when the verification result is negative or the risk/security level is unacceptable.

In some aspects, the AI-based system 102 with a security level combining subsystem (not shown in FIG. 2) may be configured to produce a combined security level based on multiple signals. The multiple signals may comprise at least one of: a biometric output from the biometric extraction, ID signals from the ID card processing pipeline, template signals from the ID template extraction, and a device blueprint score from device verification. The biometric output may indicate a confidence level that the face image captured from the one or more second users 108 matches the facial template extracted from the government-issued photo id. The ID signals may indicate confidence levels from the on-device machine learning model for ID card detection and classification. The template signals may indicate verification results from the third-party DMV-integrated security service. The device blueprint score may indicate a trustworthiness level of the one or more second electronic devices 110. The AI-based system 102 with the security level combining subsystem may be configured to calculate the combined security level by aggregating the biometric output, the ID signals, the template signals, and the device blueprint score. The combined security level may be calculated using at least one of: a weighted sum of the multiple signals, a minimum value among the multiple signals, and a machine learning model trained to combine the multiple signals. The combined security level may indicate an overall confidence in the identity and legitimacy of the one or more second users 108. The combined security level may be used by gating logic to determine whether to proceed with the financial application process, require additional verification, or terminate the application with an adverse action notice (AAN).

The plurality of subsystems 112 includes the financial application generation subsystem 218 that is communicatively connected to the one or more hardware processors 204. The financial application generation subsystem 218 is configured to generate the one or more financial applications including the one or more agreement based electronic documents for the one or more payment processes. The one or more agreement based electronic documents may include at least one of: the information associated with the one or more credit amounts, and the one or more truth in lending agreements (TILA). Generating the one or more financial applications may refer to a process of creating and assembling the one or more financial applications based on the qualification determination and acceptance of the risk-based pricing options by the one or more second users 108. The financial application generation subsystem 218 is configured to populate one or more document templates with the one or more second data, the one or more confirmed information, and the computed credit information. The financial application generation subsystem 218 is further configured to generate the one or more agreement based electronic documents by compiling the populated document templates. The one or more financial applications may refer to electronic loan applications that are created for the one or more second users 108 upon successful qualification and acceptance of loan offers. The one or more agreement based electronic documents may refer to digital documents that contain terms, conditions, and agreements associated with the one or more credits that the one or more second users 108 must review and accept for the one or more payment processes. The one or more payment processes may refer to procedures for disbursing the one or more credits to the one or more first users 104 and collecting repayments from the one or more second users 108.

The information associated with one or more credit amounts may refer to details of the loan including the principal amount, interest rate, monthly payment amount, total repayment amount, and repayment schedule. The one or more truth in lending agreements (TILA) may refer to federally required disclosure documents that provide the one or more second users 108 with clear information about the cost of credit, including annual percentage rate, finance charges, total payments, and payment schedule. For example, the financial application generation subsystem 218 may generate a financial application for a second user comprising agreement based electronic documents including information associated with a credit amount of $25,000 at an interest rate of 7.99% with monthly payments of $506 over 60 months, and a truth in lending agreement disclosing an annual percentage rate of 8.25%, total finance charges of $5,360, and total payments of $30,360.

The financial application generation subsystem 218 is configured to generate one or more summaries associated with the one or more credits to be sent to the one or more second electronic devices 110 of the one or more second users 108 upon mapping of the one or more second data with the one or more third data. The financial application generation subsystem 218 is further configured to determine one or more credit qualifications of the one or more second users 108 based on a hard pull process through a global distribution system (GDS). The financial application generation subsystem 218 is further configured to generate the one or more financial applications in the form of the one or more agreements for one or more payment processes when the one or more credit qualifications of the one or more second users 108 exceed one or more predetermined values.

The one or more summaries may refer to consolidated reports generated upon successful mapping of the one or more second data with the one or more third data, providing an overview of the one or more credits including loan amount, interest rate, repayment terms, and payment schedule for the one or more second users 108. Mapping may refer to a process of comparing and matching the one or more second data obtained from the one or more second electronic devices 110 with the one or more third data associated with the one or more identities of the one or more second users 108 to verify accuracy and authenticity of the information. The hard pull process may refer to a comprehensive credit inquiry that retrieves a complete credit report of the one or more second users 108, which may affect the credit score of the one or more second users 108 and provides detailed credit history information. The global distribution system (GDS) may refer to a network or platform that connects to one or more credit bureaus to retrieve credit reports and credit scores of the one or more second users 108. The one or more credit qualifications may refer to credit scores, credit ratings, or creditworthiness assessments of the one or more second users 108 determined based on the hard pull process. The one or more predetermined values may refer to threshold credit scores or creditworthiness levels that the one or more second users must exceed to qualify for the one or more financial applications. For example, the financial application generation subsystem 218 may generate a summary indicating a loan amount of $25,000 at 7.99% interest for 60 months upon mapping the second user name and address with identity documents, perform a hard pull process through the GDS to retrieve a credit score of 720 for the second user 108, compare the credit score of 720 with a predetermined value of 650, and generate the financial application because the credit qualification of 720 exceeds the predetermined value of 650.

When the one or more second users 108 are determined to be qualified for the getting the one or more credits, the application for the loan offers to the one or more second users 108, is approved. The one or more second electronic devices 110 obtain one or more autopay information from the one or more second users 108 through at least one of: linking account to pay, capturing bank account information from a check routing number and account number, and information associated with one or more financial devices (e.g., debit card, credit card, and the like).

The financial application generation subsystem 218 is configured to show credit score and payment details to be paid to the one or more second electronic devices 110 of the one or more second users 108. The financial application generation subsystem 218 is further configured to show at least one of: master promissory note (MPN), and an agreement. The financial application generation subsystem 218 is further configured to allow the one or more second users 108 to digitally sign and date of the agreement. The financial application generation subsystem 218 is further configured to show the one or more electronic regulatory documents including at least one of: exact loan amount (ELA), the truth in lending agreement (TILA), and the like.

The plurality of subsystems 112 includes the output subsystem 226 that is communicatively connected to the one or more hardware processors 204. The output subsystem 226 is configured to provide the output of the generated the one or more financial applications in form of the one or more agreement based electronic documents on a user interface associated with the one or more second electronic devices 110 of the one or more second users 108. The output subsystem 226 may refer to a component that is configured to deliver the generated one or more financial applications to the one or more second users 108. The output may refer to the generated one or more financial applications in form of the one or more agreement based electronic documents that are ready for review, acceptance, and digital signature by the one or more second users 108. The user interface may refer to a visual display on the one or more second electronic devices 110 through which the one or more second users 108 interact with the one or more financial applications, including viewing the one or more agreement based electronic documents, reviewing credit amounts and terms, and providing digital signatures. The user interface may be provided through at least one of: a mobile application, a web application, and a local browser on the one or more second electronic devices 110. For example, the output subsystem 226 may provide an output of a generated financial application comprising a loan agreement for $25,000 at 7.99% interest and a truth in lending agreement on a user interface of a smartphone associated with a second user 108, wherein the user interface displays the agreement based electronic documents with options to review each document, accept the terms, and digitally sign the documents.

The plurality of subsystems 112 includes the payment processing subsystem 222 that is communicatively connected to the one or more hardware processors 204. The payment processing subsystem 222 is configured to select the one or more projects from a list of one or more ongoing projects associated with the one or more second users 108. The payment processing subsystem 222 is further configured to generate one or more options (i.e., one or more first options) associated with the one or more projects. In an embodiment, the one or more first options may include at least one of: creation of one or more payment requests, one or more update statuses of the one or more projects, one or more updated details of the one or more projects. The payment processing subsystem 222 is further configured to obtain at least one first option (e.g., creation of one or more payment requests) associated with the one or more projects selected by the one or more first electronic devices 106 of the one or more first users 104. In an embodiment, the one or more first electronic devices 106 of the one or more first users 104 may have an option to select a percentage of a total amount from 0 to 100% (in increments of 10) or to input an amount (i.e., greater than the total cost of the one or more projects and greater than the approved amount). In another embodiment, the one or more first electronic devices 106 of the one or more first users 104 may have an option to include one or more pictures of completed work associated with the one or more projects.

The one or more first electronic devices 106 of the one or more first users 104 is configured to submit a request, which triggers a notification message to the one or more second electronic devices 110 of the one or more second users 108. The one or more second electronic devices 110 of the one or more second users 108 are configured to show “tasks” in the application so that the one or more second users 108 aware on a required action when the one or more second users 108 are logged in to the application. Upon clicking “tasks”, the payment processing subsystem 222 is configured to display the payment request. The second electronic devices 110 of the one or more second users 108 may be configured to either accept or reject the payment request. If the one or more second electronic devices 110 of the one or more second users 108 choose to reject the payment request, the payment processing subsystem 222 is configured to allow the second electronic devices 110 of the one or more second users 108 to confirm the decision before rejecting the payment request. If rejecting the payment, the payment processing subsystem 222 is configured to contact the one or more first electronic devices 106 of the one or more first users 104 to communicate reasons for rejections and to resubmit the payment request. The payment processing subsystem 222 is further configured to send a notification message to the one or more first electronic devices 106 of the one or more first users 104, indicating that the one or more second electronic devices 110 of the one or more second users 108 has rejected the payment request and should be contacted to resolve the payment request. If the one or more second electronic devices 110 of the one or more second users 108 take no action on the above said payment processes, the payment processing subsystem 222 is configured to send one or more reminders in a predetermined time duration. In an embodiment, the one or more first electronic devices 106 of the one or more first users 104 may also get the one or more reminders that the one or more second electronic devices 110 of the one or more second users 108 has not taken any action on the payment processes and the one or more first electronic devices 106 of the one or more first users 104 must contact the one or more second electronic devices 110 of the one or more second users 108.

The payment processing subsystem 222 is configured to initiate the one or more payment processes when the one or more second electronic devices 110 of the one or more second users 108 accept the at least one first option. In an embodiment, If the payment request is the first payment request, then the loan will be considered as funded/originated at this point. If the payment request is the last payment request, then the project will be marked as completed for both the one or more first users 104 and the one or more second users 108. The payment processing subsystem 222 is configured to re-send the at least one first option selected by the one or more first electronic devices 106 of the one or more first users 104, to the one or more second electronic devices 110 of the one or more second users 108, upon contacting with the one or more second users 108 through the one or more second electronic devices 110 when the one or more second users 108 reject the at least one first option through the one or more second electronic devices 110.

The payment processing subsystem 222 may refer to a component of the AI-based system 102 configured to manage payment requests and transactions between the one or more first users 104 and the one or more second users 108 for the one or more projects. Selecting the one or more projects may refer to identifying and retrieving a specific project from a list of one or more ongoing projects associated with the one or more second users 108 for which payment actions are to be performed. The one or more ongoing projects may refer to projects that have been initiated and are currently in progress, for which the one or more financial applications have been generated and the one or more credits have been approved.

The one or more first options may refer to actions available to the one or more first users 104, including creation of one or more payment requests for completed work, one or more update statuses indicating current progress of the one or more projects, and one or more updated details reflecting modifications to project scope or cost. Obtaining at least one first option may refer to receiving a selection made by the one or more first users 104 through the one or more first electronic devices 106 indicating a desired action such as requesting payment. Sending the at least one first option may refer to transmitting the selected action from the one or more first electronic devices 106 to the one or more second electronic devices 110 for review and approval. Determining whether the one or more second users 108 accept may refer to evaluating the response from the one or more second electronic devices 110 indicating approval or rejection of the at least one first option.

Initiating the one or more payment processes may refer to starting the disbursement of funds to the one or more first users 104 when the one or more second users 108 accept the at least one first option. Re-sending the at least one first option may refer to transmitting the selected action again to the one or more second electronic devices 110 after contacting the one or more second users 108 to resolve issues when the one or more second users 108 initially reject the at least one first option. For example, the payment processing subsystem 222 may select a bathroom renovation project from a list of ongoing projects, generate first options including a payment request for $5,000 representing 25% completion, obtain the payment request selected by a contractor through a first electronic device 106, send the payment request to a homeowner through a second electronic device 110, determine that the homeowner rejects the payment request due to incomplete tile work, contact the homeowner to discuss the rejection, and re-send the payment request after the contractor completes the tile work, wherein the homeowner accepts the re-sent payment request and the payment processing subsystem 222 initiates the payment process to disburse $5,000 to the contractor.

The plurality of subsystems 112 includes the user validation subsystem 224 that is communicatively connected to the one or more hardware processors 204. Out of network, the one or more first users 104 may search for the application on a web and from the “join the network” page, the one or more first users 104 join the network by entering their phone number and other information. The one or more first users 104 may receive a text message and may download the application on the one or more first electronic devices 106. An in-network first users 104 may receive a hot link from their enterprise and when the first users 104 download the application, one or more required information may be prepopulated. The data obtaining subsystem 210 is configured to obtain below information through the application.

First User 104 Completing the application

| | | |
|---|---|---|
| First Name | Last Name | Position within the company |
| Email | Work Phone | Mobile Phone |

Information about the Business

| | | |
|---|---|---|
| Business Category (s) | Legal Business Name | Website/Business URL |
| Are you an owner | Sponsor No/Referred by | Federal Tax ID number |
| Contractor License and | All names you are doing | In Business Since |
| state | business as | MM/DD/YYYY |
| Business Structure (drop | Types of services (fill in the | Annual Consumer |
| down) | blank) | Sales per Year |
| Current Annual Finance | Average Size project, | Physical Address of |
| Volume | dollars | the business |
| Mailing address of the | Primary Customer Credit/ | Primary Financial |
| business (box)to check if | Service. Name, Email, | Contact. Name, email, |
| same ad physical address) | Mobile No. Work Phone Number | Mobile No., Work Phone Number. |
| Business Banking | | |
| Information: Bank Name, | | |
| Name on Bank Account, | | |
| Routing Number, Account | | |
| Number | | |

Principal/Owner with the largest percentage of the business
(must be the majority shareholder . . . per SES 8/30

| | | |
|---|---|---|
| Full Name | Residential address | Mobile Phone |
| Email | Date of Birth | Social Security Number |
| Owner since MM/YYYY | Job Title | Percent of Ownership |

The user validation subsystem 224 is configured to validate the one or more first users 104 based on a clear identity confirm process. For validating the one or more first users 104, the user validation subsystem 224 is configured to obtain one or more fifth data associated with the one or more first users 104 from the one or more first electronic devices 106 of the one or more first users 104. The user validation subsystem 224 is further configured to compare the one or more fifth data associated with the one or more first users 104 with one or more first prestored data associated with the one or more first users 104 retrieved from one or more clear databases. The user validation subsystem 224 is further configured to generate one or more confidence scores for the one or more first users 104 based on the comparison of the one or more fifth data associated with the one or more first users 104 with the one or more first prestored data associated with the one or more first users 104. The user validation subsystem 224 is further configured to classify the one or more first users 104 based on the one or more confidence scores generated for the one or more first users 104. The user validation subsystem 224 is further configured to determine whether the one or more first electronic devices 106 of the one or more first users 104 need to provide one or more sixth data (i.e., further required information) based on the classification of the one or more first users 104. In an embodiment, the one or more confidence scores may range from 0 to 100.

The user validation subsystem 224 may refer to a component of the AI-based system 102 configured to verify the identity and authenticity of the one or more first users 104 before allowing them to participate in the financial application process. The clear identity confirm process may refer to a verification procedure that validates the identity of the one or more first users 104 by comparing provided information with data retrieved from external databases. The one or more fifth data may refer to identity information provided by the one or more first users 104 through the one or more first electronic devices 106, including at least one of: name, address, phone number, email, federal tax identification number, business name, and social security number. The one or more first prestored data may refer to previously stored identity information associated with the one or more first users 104 that is retrieved from the one or more clear databases for comparison purposes. The one or more clear databases may refer to external databases containing verified identity and business information, such as business registries, credit bureaus, and government databases.

The one or more confidence scores may refer to numerical values ranging from 0 to 100 that indicate the degree of match between the one or more fifth data and the one or more first prestored data, wherein higher scores indicate greater confidence in the identity of the one or more first users 104. Classifying the one or more first users 104 may refer to categorizing the one or more first users 104 based on the one or more confidence scores, wherein a score of 100 indicates a match, a score greater than 95 and less than 100 may require additional information, a score between 80 and 95 indicates a good chance additional information is needed, and a score of 79 and below may require additional information. The one or more sixth data may refer to additional identity information that the one or more first users 104 may need to provide when the one or more confidence scores indicate insufficient verification. For example, the user validation subsystem 224 may obtain fifth data including a business name of ABC Contractors and a federal tax identification number from a first user 104, compare the fifth data with first prestored data retrieved from clear databases, generate a confidence score of 92 indicating a good chance additional information is needed, classify the first user 104 as requiring additional verification, and determine that the first user 104 needs to provide sixth data including a copy of business license and liability insurance to complete the validation process.

The determination of the required information to be given by the one or more first users 104 based on the one or more confidence scores is given in a below table.

| Confidence Scores | Classification |
|---|---|
| 100 | Match |
| >95 and <100 | May require additional |
| | information |
| 80-95 | Good chance additional |
| | information is needed |
| 79 and below | May require additional |
| | information |

Based on the results received from the clear identity confirm process, the user validation subsystem 224 is configured to show top three responses to the one or more first electronic devices 106 of the one or more first users 104 and allow the one or more first electronic devices 106 of the one or more first users 104 to select which entity they are or to indicate none are correct.

In an embodiment, the below table shows fields/results returned by the clear identity and the fields used in a business model.

| | | | |
|---|---|---|---|
| | | | Used in |
| | | | the |
| Company | Company | Record | Business |
| Entities | Entity | Number | Model |

| | | | |
|---|---|---|---|
| TotalScore | | | Yes |
| EntityIdentifier | | | Yes |
| Summary | | | No |
| SearchRecords | SearchRecord | ContentSource [Business | Yes |
| | | Profile] | |
| | | ContentScore | Yes |
| | | DocumentIdentifier | No |
| | | BusinessName | Yes |
| | | CorporationId | No |
| | | FeinNumber | Yes |
| | | NPINumber | Yes |
| | | DunsNumber | No |
| | | StreetNumber | Yes |
| | | StreetName | Yes |
| | | City | Yes |
| | | State | Yes |
| | | Zipcode | Yes |
| | | Country | No |
| | | OfficerAgentFirstName | No |
| | | OfficerAgentMiddleName | No |
| | | OfficerAgentLastName | No |
| | SearchRecord | ContentSource [FEIN] | Yes |
| | | ContentScore | Yes |
| | | DocumentIdentifier | No |
| | | BusinessName | Yes |
| | | CorporationId | No |
| | | FeinNumber | Yes |
| | | NPINumber | Yes |
| | | DunsNumber | No |
| | | StreetNumber | Yes |
| | | StreetName | Yes |
| | | City | Yes |
| | | State | Yes |
| | | Zipcode | Yes |
| | | Country | No |
| | | OfficerAgentFirstName | No |
| | | OfficerAgentMiddleNam | No |
| | | OfficerAgentLastName | No |
| | SearchRecord | ContentSource [Dan and | Yes |
| | | Bradstreet] | |
| | | ContentScore | Yes |
| | | DocumentIdentifier | No |
| | | BusinessName | Yes |
| | | CorporationId | No |
| | | FeinNumber | Yes |
| | | NPINumber | Yes |
| | | DunsNumber | No |
| | | StreetNumber | Yes |
| | | StreetName | Yes |
| | | City | Yes |
| | | State | Yes |
| | | Zipcode | Yes |
| | | Country | No |
| | | OfficerAgentFirstName | No |
| | | OfficerAgentMiddleName | No |
| | | OfficerAgentLastName | No |
| | SearchRecord | ContentSource [Corporate | Yes |
| | | Filing] | |
| | | ContentScore | Yes |
| | | DocumentIdentifier | No |
| | | BusinessName | Yes |
| | | CorporationId | No |
| | | FeinNumber | Yes |
| | | NPINumber | Yes |
| | | DunsNumber | No |
| | | StreetNumber | Yes |
| | | StreetName | Yes |
| | | City | Yes |
| | | State | Yes |
| | | Zipcode | Yes |
| | | Country | No |
| | | OfficerAgentFirstName | No |
| | | OfficerAgentMiddleName | No |
| | | OfficerAgentLastName | No |
| | SearchRecord | ContentSource [Business | Yes |
| | | Phone] | |
| | | ContentScore | Yes |
| | | DocumentIdentifier | No |
| | | BusinessName | Yes |
| | | CorporationId | No |
| | | FeinNumber | Yes |
| | | NPINumber | Yes |
| | | DunsNumber | No |
| | | StreetNumber | Yes |
| | | StreetName | Yes |
| | | City | Yes |
| | | State | Yes |
| | | Zipcode | Yes |
| | | Country | No |
| | | OfficerAgentFirstName | No |
| | | OfficerAgentMiddleName | No |
| | | OfficerAgentLastName | No |
| | SearchRecord | ContentSource [Phone | Yes |
| | | Record] | |
| | | ContentScore | Yes |
| | | DocumentIdentifier | No |
| | | BusinessName | Yes |
| | | CorporationId | No |
| | | FeinNumber | Yes |
| | | NPINumber | Yes |
| | | DunsNumber | |
| | | StreetNumber | Yes |
| | | StreetName | Yes |
| | | City | Yes |
| | | State | Yes |
| | | Zipcode | Yes |
| | | Country | No |
| | | OfficerAgentFirstName | No |
| | | OfficerAgentMiddleName | No |
| | | OfficerAgentLastName | No |
| | SearchRecord | ContentSource | Yes |
| | | [Worldbase] | |
| | | ContentScore | Yes |
| | | DocumentIdentifier | No |
| | | BusinessName | Yes |
| | | CorporationId | No |
| | | FeinNumber | Yes |
| | | NPINumber | Yes |
| | | DunsNumber | No |
| | | StreetNumber | Yes |
| | | StreetName | Yes |
| | | City | Yes |
| | | State | Yes |
| | | Zipcode | Yes |
| | | Country | No |
| | | OfficerAgentFirstName | No |
| | | OfficerAgentMiddleName | No |
| | | OfficerAgentLastName | No |

In other words, the user validation subsystem 224 is configured to obtain one or more inputs from the one or more first electronic devices 106 of the one or more first users 104. The one or more inputs may include a selection of one or more entities on which the one or more first users 104 are belonging to. The user validation subsystem 224 is further configured to compare the one or more inputs with one or more second prestored data based on a clear risk inform search process. The user validation subsystem 224 is further configured to generate one or more risk scores for the one or more first users 104 based on the comparison of the one or more inputs with the one or more second prestored data. The user validation subsystem 224 is further configured to determine one or more optimum first users based on the one or more risk scores generated for the one or more first users 104. In an embodiment, if the one or more first electronic devices 106 of the one or more first users 104 indicate none of the responses indicating their company, the application corresponding to the one or more first users 104 is marked for a manual review and contact with a new first user.

The one or more inputs may refer to information received from the one or more first electronic devices 106 of the one or more first users 104, including a selection of one or more entities on which the one or more first users 104 are belonging to. The one or more entities may refer to business organizations, companies, or establishments that the one or more first users 104 are associated with or claim ownership of, which are presented as options for the one or more first users 104 to select from based on results of the clear identity confirm process. The one or more second prestored data may refer to previously stored risk-related information associated with businesses and entities, including at least one of: address verification, business license discipline, length of time business has been established, corporate filings, bankruptcy records, tax liens, lawsuits, and sanctions. The clear risk inform search process may refer to a verification procedure that evaluates the risk profile of the one or more first users 104 by comparing the one or more inputs with the one or more second prestored data retrieved from external risk databases.

The one or more risk scores may refer to numerical values ranging from 0 to 100 that indicate the risk level associated with the one or more first users 104, wherein lower scores indicate better results and lower risk. The one or more optimum first users 104 may refer to first users 104 who have been determined to have acceptable risk levels based on the one or more risk scores, wherein an optimum user category may range from 0 to 19, an average user category may range from 20 to 30, a low user category may range from 31 to 40, and a failed user category may range from 41 to 100. For example, the user validation subsystem 224 may (a) obtain an input from a first user 104 selecting ABC contractors from a list of three entities displayed after the clear identity confirm process, (b) compare the selection with second prestored data indicating no tax liens, no lawsuits, and 10 years in business, (c) generate a risk score of 15 for the first user 104, and (d) determine that the first user 104 is an optimum first user eligible for onboarding because the risk score of 15 falls within the optimum user category range of 0 to 19.

The information of the business that the user validation subsystem 224 checks is given in a below table.

| | |
|---|---|
| Address | No corporate filings tied to business |
| Business License Discipline | Other businesses linked to the business address |
| Length of time business has been established. | URL/Company website |
| If the company is inactive | Principals and executives tied to business |
| Global Sanctions | Bankruptcy-business and personal |
| Is it a going concern | Environmental |
| OFAC | Asbestos |
| Other business linked to the business phone no. | Labor and Employment |
| Pending class action | Lawsuits |
| Suspected out of business | Federal tax liens |
| Corporate filings | State tax liens |
| Doing business as | Miscellaneous liens |
| Industry classification code | Party to risk related lawsuits |
| Google Construction Defect | |

The one or more risk scores for the one or more first users 104 may range from 0 to 100. The lower the risk scores include better results. In an embodiment, optimum user category may range from 0 to 19, an average user category may range from 20 to 30, low user category may range from 31 to 40, and failed user category may range from 41 to 100.

In an embodiment, the user validation subsystem 224 is further configured to check for social media reviews at Google and Yelp, which is given in a below table.

| Scoring | Google | Yelp | |
|---|---|---|---|
| Attribute | Attribute | Attribute | Score Assignment |
| Overall | user_ratings_total | review_count | Assign score as follows: |
| number of | | | No reviews ever: −10, |
| ratings (S1) | | | 1-9 reviews: −5, |
| | | | 10 or more reviews: 0 |
| Overall rating | rating | rating | If total number of ratings is |
| (S2) | | | zero, then assign a score of |
| | | | zero. Otherwise assign score |
| | | | as follows: |
| | | | Overall rating of 1: −10 |
| | | | Overall rating of 2 or 3: −5, |
| | | | Overall rating of 4 or more: 0 |
| Phone number | formatted_phone_ | Phone | If the input phone number is |
| same as input? | number | | the same as the phone number |
| (S3) | | | on the API response, then |
| | | | assign a score of 0, else −10. |
| | | | Note: assign a score of −5, if |
| | | | the API response does not |
| | | | return a phone number |
| Zipcode same | zip (from | zip_code | If the input zipcode is the |
| as input? (S4) | formatted_address) | | same as the zipcode on the |
| | | | API response, then assign a |
| | | | score of 0, else −10. |
| | | | Note: assign a score of −5, if |
| | | | the API response does not |
| | | | return a zipcode |
| Is the business | business_status | Not | If value is “OPERATIONAL”, |
| operational? | | applicable | then score = 0, else score = −10. |
| (S5) | | | This attribute applies only to |
| | | | google reviews. |
| | | | For Yelp, assign a score of 0. |

In an embodiment, a next part of the scoring is based on an availability of individual reviews. The user validation system 224 is configured to consider count of ratings in 1 to 3 months as A, count of ratings in 4 to 6 months as B, and total count of ratings as C. The average ratings in 1 to 3 months as X (i.e., average rating would be 0, if no ratings in the time period). The average ratings in 4 to 6 months as Y (i.e., average rating would be 0, if no ratings in the time period). The average ratings in overall is Z (i.e., average rating would be 0, if no ratings ever). In an embodiment, N is a number of months since first rating. In another embodiment, G is a number of 1-star ratings in months 1 to 3.

An algorithm for recent change in the number of ratings (S6) is given below.

If C=0 {
S6=0
}
Else {
If A=0 and B=0: S6 = −0.5
Else: S6 = (A−B)/(C/N); apply a floor and ceiling of {−2, +2}
}

An algorithm for score for recent change in the ratings (S7) is given below.

If C=0 {
S7=0
}
Else {
If A=0 and B=0: S7 = 0
If A>0 and B=0: S7 = X − Z − 0.5
If A>0 and B>0: S7 = min(X − Y, X − Z)
If A>0 and B>0: S7 = Y − Z − 0.5
}

An algorithm for score for recent adverse ratings (S8) is given below.

If C=0 {
S8=0
}
Else {
S8 = (G\hat{ }2/A)*(−1); apply a floor and ceiling of {−10, 0}

The user validation subsystem 224 is configured to determine business risk score (BRS) (i.e., sum of Si to S8) based on overall business risk rating BRR as given below.

| | BUSINESS RISK RATING |
|---|---|
| BRS | (BRR) |
| Less than −10 | RED |
| >=−10 and <−5 | AMBER |
| >=−5 and <0 | YELLOW |
| Zero or More | GREEN |

In an embodiment, the AI-based system 102 provides initial calibrations for an automated merchant risk rating system. In an embodiment, the AI-based system 102 is configured to use total score from a clear ID search API response to determine clear ID search risk rating (CIDSRR) as follows.

| | |
|---|---|
| 100 | Green |
| >95 AND <100 | Yellow |
| 80-95 | Amber |
| <80 | Red |

In an embodiment, the AI-based system 102 is configured to use risk inform total score from the clear ID search API response to determine clear risk inform risk rating (CRIRR) as follows.

| 5 or less | Green |
|---|---|
| >5 and <=15 | Yellow |
| >15 and <=20 | Amber |
| >20 | Red |

In an embodiment, the business risk rating (BRR) may be the worst of the four ratings described above. A green BRR may be achieved if all four ratings are green. An yellow BRR rating may be assigned if the worst of the four ratings is yellow. A red rating on any one of the four ratings may result in a BRR of red. In an embodiment, rules for onboarding of the one or more first users 104 are given below.

| BRR | Action |
|---|---|
| Green | Onboard the first user 104, and review |
| | them manually within 3 months |
| Yellow | Onboard the first user 104, and review |
| | them manually within a month |
| Amber | Pend the first user 104, and |
| | approve/decline upon manual review |
| Red | Decline |

In an embodiment, for the one or more first users 104 who are qualified to onboard, the AI-based system 102 is configured to display the information based on the business from Clear for verification. If Clear does not have the data, the information inputted by the one or more first users 104 might be displayed. The one or more first users 104 should have the ability to edit the data presented. If the one or more first users 104 materially edits the displayed info name, DBA, city and state of business address, Tax ID number, the AI-based system 102 is configured to process the one or more first users 104 again through clear risk inform using the new edited information. The process repeats.

If the one or more first users 104 confirms the data, the AI-based system 102 is configured to inform the one or more first users 104 that the one or more first users 104 are approved with additional information. The AI-based system 102 receives for an image of their liability insurance declaration page and all business licenses. The images are sent to a provider (TBD) to read and provide the data to the application. If the documents satisfy the requirement, a final approval is given to the one or more first users 104. If the documents do not satisfy the requirements or are unreadable, a manual review of the documents is required.

In an embodiment, the AI-based system 102 may send a new communication to the one or more first electronic devices 106 of the one or more first users 104 to indicate that the application is in progress and the application may contact the one or more first users 104. When the one or more first electronic devices 106 of the one or more first users 104 informs the application that none of the top three clear ID confirm entries displayed to the one or more first electronic devices 106 of the one or more first users 104, are accurate. When the application of the one or more first users 104 is pending due to the clear risk inform and/or social media score requires a manual review. In an embodiment, the AI-based system 102 may generate an activity and portfolio performance report, which include at least one of: monthly, quarterly and year to date, a number of applications, by product type and amount, number of approval applications by product type and amount, number of funding of approved applications by product type and amount, fico and Vantage score high, low and median, and loan portfolio including at least one of: number, dollar, weighted average remaining term, weighted average interest rate, number and dollar 30, 60, 90, and 120, number and dollar charged off, number having autopay, number and dollar of loans that have had a UCCI files, and the like.

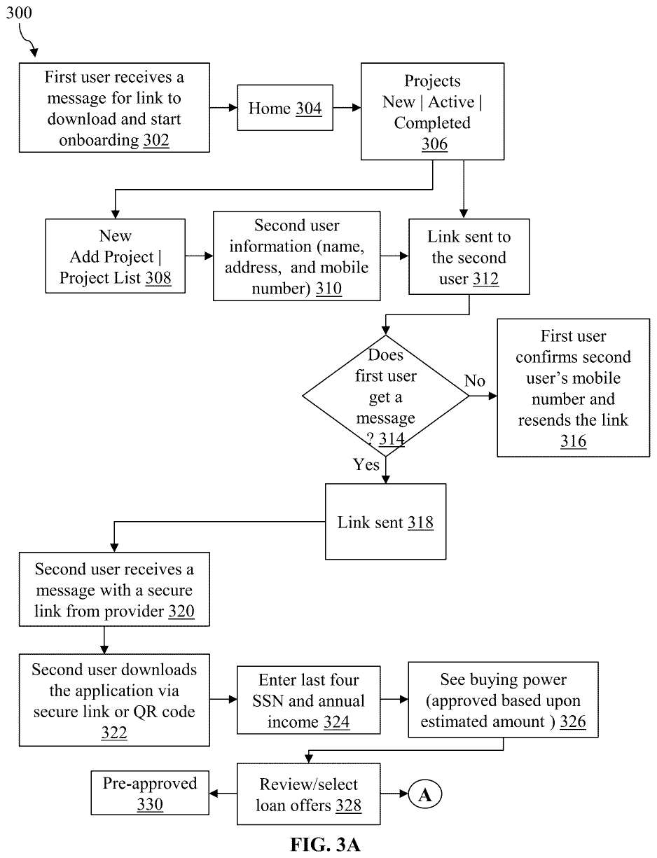

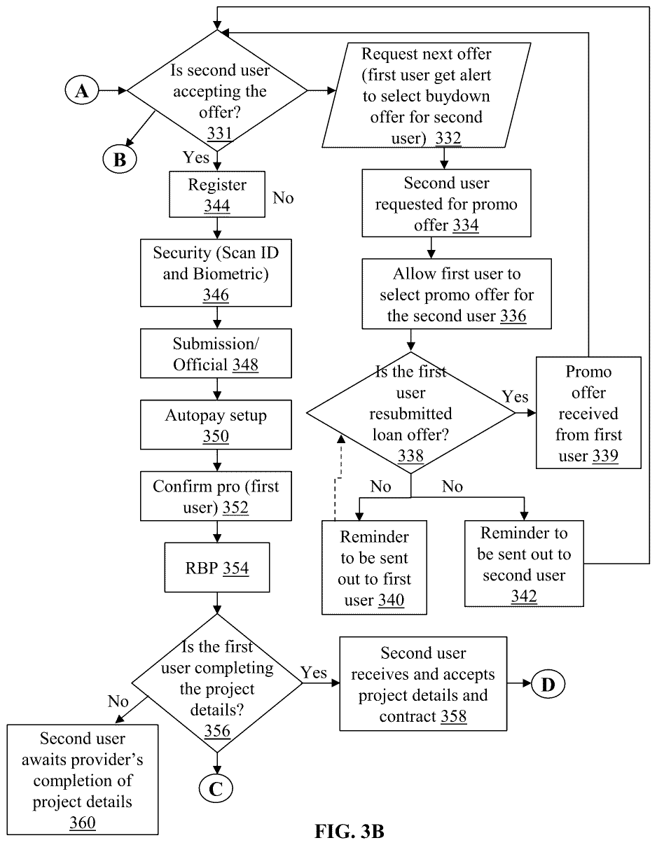

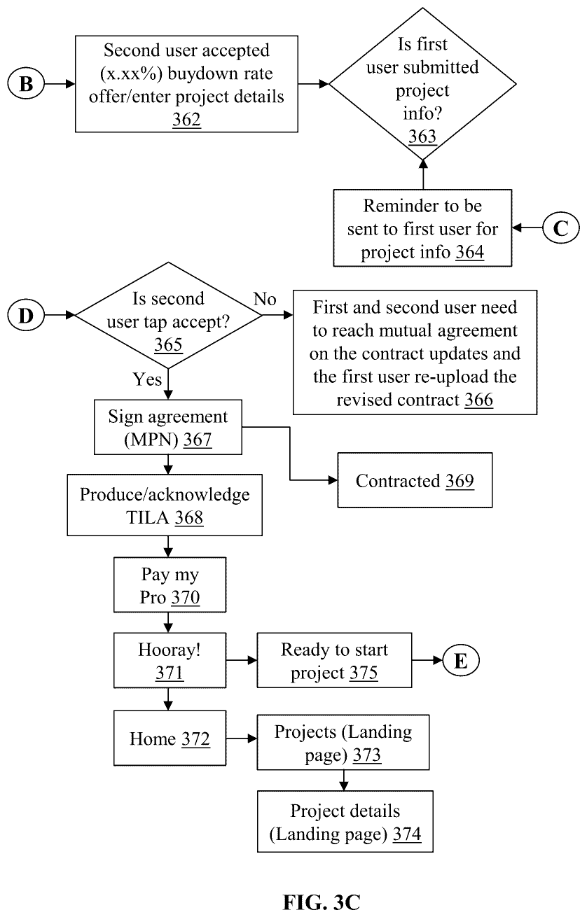

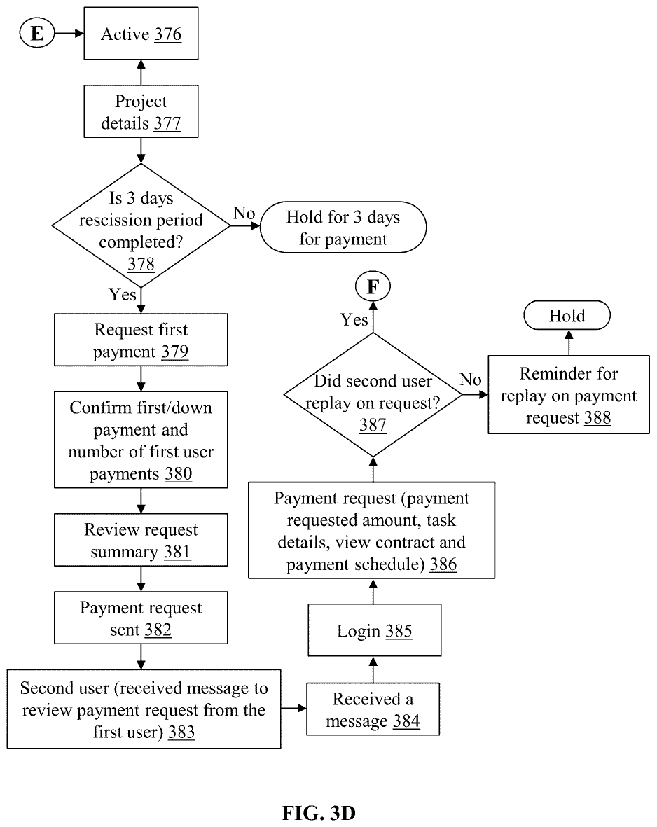

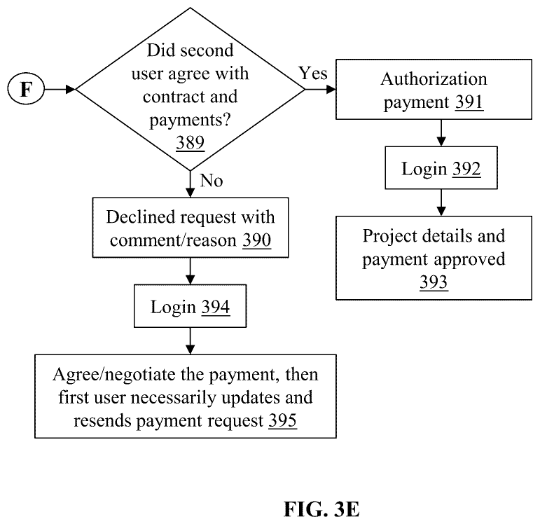

FIG. 3A-3E is an overall process flow 300 of generating the one or more financial applications for the one or more second users 108, in accordance with another embodiment of the present disclosure. At step 302, the one or more first electronic devices 106 of the one or more first users 104 receive the message for the application link to download the application and start onboarding. At step 304, the one or more first users 104 are logged into the application. At step 306, the one or more first electronic devices 106 of the one or more first users 104 select the one or more projects (e.g., new project, active project and completed project). At step 308, the one or more first electronic devices 106 of the one or more first users 104 select the add project option from the screen. At step 310, the one or more first electronic devices 106 of the one or more first users 104 input the information of the one or more second users 108 and the application link is sent to the one or more second electronic devices 110 of the one or more second users 108, as shown in step 312.

At step 314, the AI-based system 102 checks whether the one or more second electronic devices 110 of the one or more second users 108 receive a message. If yes, the application link is sent to the one or more second electronic devices 110 of the one or more second users 108, as shown in step 318. If no, the one or more first electronic devices 106 of the one or more first users 104 confirm the mobile number of the one or more second users 108 and resend the application link to the one or more second electronic devices 110 of the one or more second users 108, as shown in step 316. At step 320, the one or more second electronic devices 110 of the one or more second users 108 receive a message with a secure link from the one or more first electronic devices 106 of the one or more first users 104. At step 322, the one or more second electronic devices 110 of the one or more second users 108 download the application through the secured link or the QR code. At step 324, the one or more second data are received from the one or more second electronic devices 110 of the one or more second users 108. At step 326, the one or more second electronic devices 110 of the one or more second users 108 sees buying power (i.e., approval based on estimated amount). At step 328, the one or more second electronic devices 110 of the one or more second users 108 reviews and selects loan offer (i.e., the first risk-based pricing options). At step 331, the AI-based system 102 checks whether the one or more second electronic devices 110 of the one or more second users 108 accept the loan offer. At step 330, the one or more second users 108 are pre-approved for the loan offers.

If the one or more second electronic devices 110 of the one or more second users 108 reject the loan offer, then the one or more first electronic devices 106 of the one or more first users 104 receive alert to select buy down loan offer (i.e., the second risk-based pricing options) for the one or more second users 108, as shown in step 332. At step 334, the one or more second electronic devices 110 of the one or more second users 108 are configured to request for promo offer. At step 336, the one or more first electronic devices 106 of the one or more first users 104 are allowed to select the promo offer for the one or more second users 108. At step 338, the AI-based system 102 checks whether the one or more first electronic devices 106 of the one or more first users 104 resubmit the loan offers. If yes, the promo offers are received from the one or more first electronic devices 106 of the one or more first users 104, as shown in step 339. If no, the one or more reminders are sent to the one or more first electronic devices 106 of the one or more first users 104, as shown in step 340, and to the one or more second electronic devices 110 of the one or more second users 108, as shown in step 342. If the one or more second electronic devices 110 of the one or more second users 108 accept the loan offer, the one or more second electronic devices 110 of the one or more second users 108 are allowed to register the loan processes into the application, as shown in step 344. At step 346, the one or more second electronic devices 110 of the one or more second users 108 are allowed to provide the biometric information and identities associated with the one or more second users 108. At step 348, the one or more second electronic devices 110 of the one or more second users 108 are allowed to submit the identities of the one or more second users 108. At step 350, the one or more second electronic devices 110 of the one or more second users 108 are allowed into the payment processes.

At step 352, the one or more second electronic devices 110 of the one or more second users 108 confirm the one or more first users 104 and the relationship based pricing (RBP) is generated at step 354. At step 356, the AI-based system 102 checks whether the one or more first electronic devices 106 of the one or more first users 104 completed the project details. If yes, the one or more second electronic devices 110 of the one or more second users 108 receive and accept the project details and contract, as shown in step 358. If no, the one or more second electronic devices 110 of the one or more second users 108 awaits second user's completion of the project details, as shown in 360. At step 362, the one or more second electronic devices 110 of the one or more second users 108 may accept the buydown loan offer at x.xx %, when the one or more second electronic devices 110 of the one or more second users 108 do not accept the loan offer, as shown in step 331. At step 363, the AI-based system 102 checks whether the one or more first electronic devices 106 of the one or more first users 104 submitted the project information. If the one or more first electronic devices 106 of the one or more first users 104 do not complete the project details, then the reminder communications are sent to the one or more first electronic devices 106 of the one or more first users 104 for the project information, as shown in step 364.

At step 365, the AI-based system 102 checks whether the one or more second electronic devices 110 of the one or more second users 108 accept the project details and contract. If no, the one or more first users 104 and the one or more second users 108 need to reach a mutual agreement on the contract updates and the one or more first electronic devices 106 of the one or more first users 104 re-upload the revised contract, as shown in step 366. If yes, the agreement is being signed digitally by the one or more second users 108 through the one or more second electronic devices 110, as shown in step 367. At step 368, the truth in lending agreement (TILA) is generated upon acknowledgement of the signed agreement. At step 369, the one or more first electronic devices 106 of the one or more first users 104 receive a notification indicating the contract between the one or more first users 104 and the one or more second users 108.

At step 370, the one or more second electronic devices 110 of the one or more second users 108 are informed to pay the one or mor first users 104. At step 371, the completion message is being displayed in form of “Hooray!”, and the page turns into home page, as shown in step 372. At step 373, the one or more projects are being displayed on the screen. At step 374, the one or more project details are being displayed on the screen. At step 375, the one or more projects are ready to start. At step 376, the one or more first electronic devices 106 of the one or more first users 104 select the active option of the one or more projects. At step 377, the one or more first electronic devices 106 of the one or more first users 104 retrieve the one or more project details corresponding to the one or more active projects. At step 378, the AI-based system 102 checks whether three days rescission period completed. If no, the process is hold for three days for payment. If yes, the one or more second electronic devices 110 of the one or more second users 108 are requested for making a first payment, as shown in step 379. At step 380, the first down payment and a number of payments made by the one or more first users 104, are confirmed. At step 381, a request summary is being reviewed by the one or more first electronic devices 106 of the one or more first users 104. At step 382, the payment request is sent to the one or more second electronic devices 110 of the one or more second users 108.

At step 383, the one or more second electronic devices 110 of the one or more second users 108 receive the message to review the payment request sent by the one or more first electronic devices 106 of the one or more first users 104. At step 384, the one or more second electronic devices 110 of the one or more second users 108 receive a text message. At step 385, the one or more second electronic devices 110 of the one or more second users 108 are logged into the application. At step 386, the one or more second electronic devices 110 of the one or more second users 108 request for the payment (i.e., request for payment amount, task details, view contract and payment schedule). At step 387, the AI-based system 102 checks whether the one or more second electronic devices 110 of the one or more second users 108 replay on the request. If no, the one or more reminder communications are sent for replay on the request, as shown in step 388. If yes, the AI-based system 102 checks whether the one or more second users 108 agree with the contract and payments, as shown in step 389. If the one or more second users 108 do not agree with the contract and payments, the request is declined with request or reason, as shown in step 390.

If yes, the authorized payment is made to the one or more second users 108, as shown in step 391. The one or more first electronic devices 106 of the one or more first users 104 receive notification for logging into the application, as shown in step 392, to approve the project details and the payments for the one or more projects, as shown in step 393. The one or more first electronic devices 106 of the one or more first users 104 receive notification for logging into the application, as shown in step 394 when the request is declined. At step 395, the payment is agreed/negotiated and then the one or more first electronic devices 106 of the one or more first users 104 necessarily updates and resends the payment request to the one or more second electronic devices 110 of the one or more second users 108. In FIG. 3A-3E, the circular symbols with “A, B, C, D, E, and F” written inside are being used as an off-page connector. These are used for indicating that FIG. 3A continues to the subsequent pages as FIG. 3B-3E.

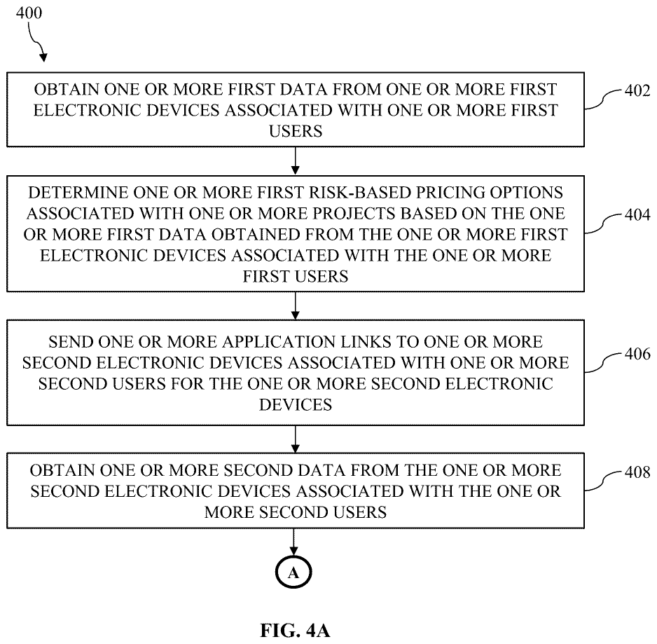

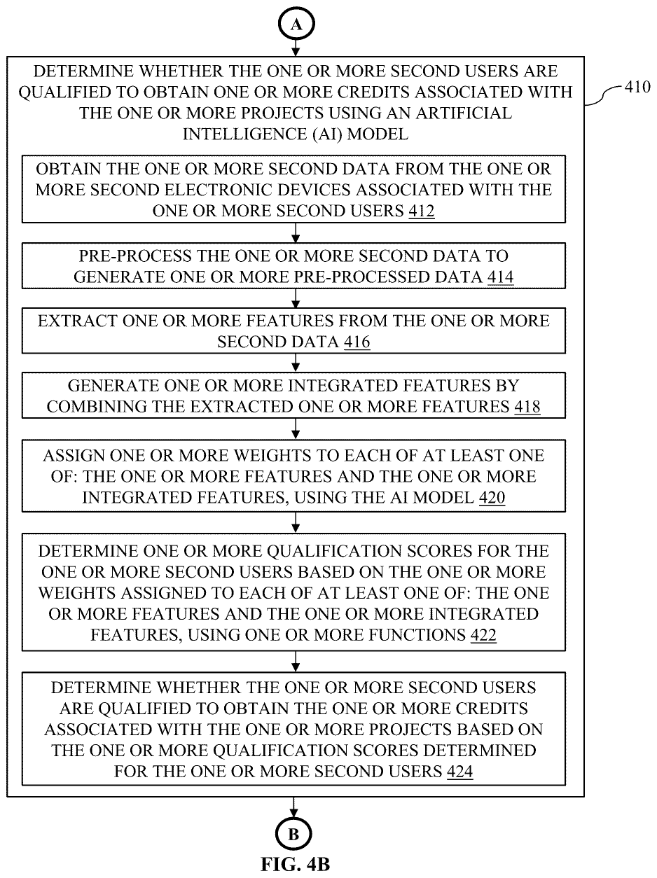

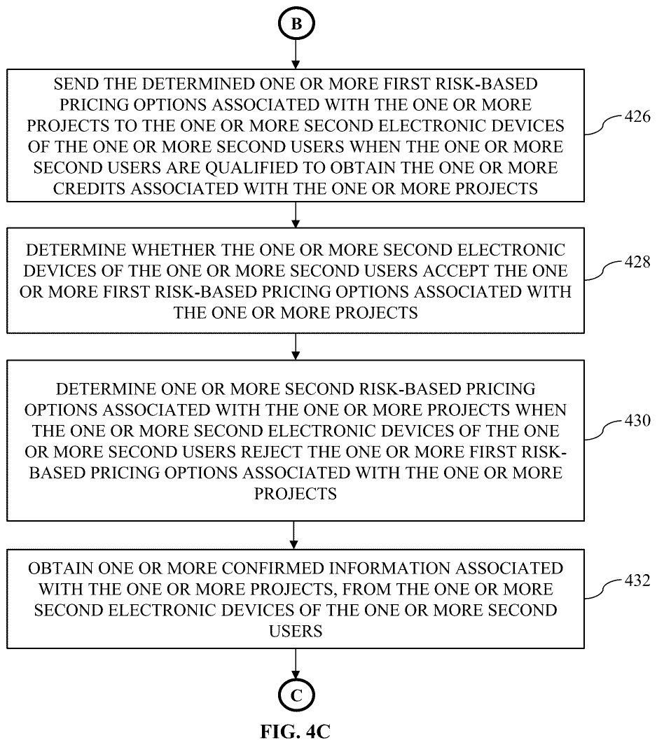

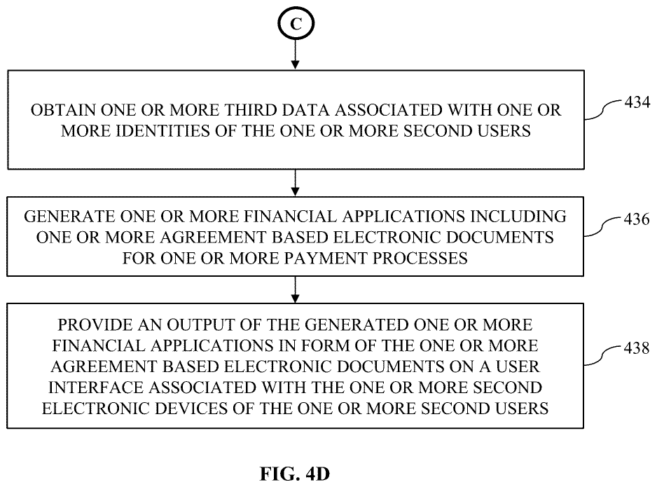

FIG. 4A-4D is a flow chart illustrating an artificial intelligence based (AI-based) method 400 for automatically generating the one or more financial applications for the one or more second users 108, in accordance with an embodiment of the present disclosure. At step 402, one or more first data are received from the one or more first electronic devices 106 associated with the one or more first users 104. In an embodiment, the one or more first data may include at least one of: the name, the phone number, and the address, of the one or more second users 108, the one or more project categories, the estimation of one or more projects, and the time duration of the one or more projects being completed.

At step 404, the one or more first risk-based pricing options associated with the one or more projects are determined based on the one or more first data obtained from the one or more first electronic devices 106 associated with the one or more first users 104.

At step 406, the one or more application links are sent to the one or more second electronic devices 110 associated with the one or more second users 108 for the one or more second electronic devices 110 to initiate one or more applications.

At step 408, the one or more second data are obtained from the one or more second electronic devices 110 associated with the one or more second users 108. In an embodiment, the one or more second data may include at least one of: the name, the phone number, the address, at least last four digits of a social security number (SSN), birth date, and annual income, of the one or more second users 108, the amount requested by the one or more second users 108, and the option for one or more third users to be added to the one or more second users 108.

At step 410, the artificial intelligence based (AI-based) system 102 determines whether the one or more second users 108 are qualified to obtain one or more credits associated with the one or more projects by the artificial intelligence (AI) model.

For determining the qualification of the one or more second users 108, the AI-model is configured to obtain the one or more second data from the one or more second electronic devices 110 associated with the one or more second users 108, as shown in step 412. The AI-model is further configured to pre-process the one or more second data to generate the one or more pre-processed data, as shown in step 414. The pre-processing of the one or more second data comprises at least one of: normalizing the one or more second data to the one or more standardized formats, identifying and managing the one or more missing data fields in the one or more second data, and validating the one or more second data against the one or more pre-defined data formats and ranges.

The AI-model is further configured to extract the one or more features from the one or more second data, as shown in step 416. The one or more features may include at least one of: the debt-to-income ratio, the credit utilization ratio, the payment history pattern, the employment stability indicator, the residential stability indicator, and the income verification indicator, of the one or more second users 108. The AI-model is further configured to generate the one or more integrated features by combining the extracted one or more features, as shown in step 418. The one or more integrated features may include at least one of: the financial stability score, the risk exposure indicator, and the repayment capacity indicator. The AI-model is further configured to assign the one or more weights to each of at least one of: the one or more features and the one or more integrated features, as shown in step 420. The one or more weights are assigned to each of at least one of: the one or more features and the one or more integrated features, based on the historical loan performance data associated with one or more previous second users.

The AI-model is further configured to determine the one or more qualification scores for the one or more second users 108 based on the one or more weights assigned to each of at least one of: the one or more features and the one or more integrated features, using one or more functions, as shown in step 422. The one or more functions may include at least one of: the weighted sum function, the sigmoid function, the softmax function, and the probability distribution function. The AI-model is further configured to determine whether the one or more second users 108 are qualified to obtain the one or more credits associated with the one or more projects based on the one or more qualification scores determined for the one or more second users 108, as shown in step 424. At step 426, the determined one or more first risk-based pricing options associated with the one or more projects are sent to the one or more second electronic devices 110 of the one or more second users 108 when the one or more second users 108 are qualified to obtain the one or more credits associated with the one or more projects. At step 428, the artificial intelligence based (AI-based) system 102 determines whether the one or more second electronic devices 110 of the one or more second users 108 accept the one or more first risk-based pricing options associated with the one or more projects. At step 430, the artificial intelligence based (AI-based) system 102 determines the one or more second risk-based pricing options associated with the one or more projects to be sent to the one or more second electronic devices 110 of the one or more second users 108 when the one or more second electronic devices 110 of the one or more second users 108 reject the one or more first risk-based pricing options associated with the one or more projects.

At step 432, the one or more confirmed information associated with the one or more projects, are obtained from the one or more second electronic devices 110 of the one or more second users 108. In an embodiment, the one or more confirmed information associated with the one or more projects may include at least one of: one or more names associated with the one or more first users 104, the one or more categories of works associated with the one or more projects, the estimation of the works associated with the one or more projects, the time duration of the one or more projects, the information associated with one or more ownerships, the one or more categories of one or more properties of the one or more second users 108.

At step 434, the one or more second data associated with one or more identities of the one or more second users 108 to map the one or more second data with the one or more third data. At step 436, the one or more financial applications including the one or more agreement based electronic documents for the one or more payment processes. In an embodiment, the one or more agreement based electronic documents may include at least one of: the information associated with the one or more credit amounts, and the one or more truth in lending agreements (TILA).

At step 438, the output of the generated one or more financial applications in form of the one or more agreement based electronic documents are provided on the user interface associated with the one or more second electronic devices 110 of the one or more second users 108. In FIG. 4A-4D, the circular symbols with “A, B, and C” written inside are being used as an off-page connector. These are used for indicating that FIG. 4A continues to the subsequent pages as FIG. 4B-4D.

The present invention has following advantages. The present invention with the AI-based system 102 is configured to outline the business requirements for the development of an unsecured consumer loan program that will enable the one or more second users 108 (e.g., the borrowers) to pay for home improvement projects. The present invention is offered through the application and supports the engagement of the one or more first users (e.g., pro/contractor/merchant) 104 and the one or more second users 108.

Further, the present invention is configured to provide a simple, seamless, and secure process for the one or more second users 108 to apply for home improvement financing. The present invention is configured to reduce the time and effort required for the one or more second users 108 to apply for home improvement loans. The present invention is configured to improve the accuracy and efficiency of the home improvement loan approval process.

The present invention is configured to provide a development of the mobile loan application for the one or more second users 108 seeking home improvement loans. The present invention is configured to provide a development of a mobile environment for the one or more first users 104 to create quotes for home improvement projects. The present invention is configured to create the payment process based on the contract and the needs of the two contracting parties (i.e., the one or more first users 104 and the one or more second users 108). The present invention is configured to develop an automated, risk-based onboarding process for participating as the one or more first users 104.

The present invention is configured to provide unsecured consumer loans for home improvement projects to the one or more second users 108 engaged by the one or more first users 104 with whom the lender has an existing relationship. The present invention is configured to enable the one or more second users 108 to submit a loan application through the application and receive prequalification eligibility based on their personal identifiable information (PII). The lender may use soft pull reports from Prove (or Transunion) to determine prequalification eligibility. The one or more second users 108 may view various loan options, and if qualified, will be provided with loan details, including the truth in lending agreement (TILA) that the one or more second users 108 must accept in the course of the application process. The present invention is configured to introduce the industry's first risk-based, automated activation of the one or more second users 108 under home improvement, leveraging data from various sources (i.e., Thompson Reuter's Clear) including digital, individual, business, professional license, reputational, social, and biometric information.

The written description describes the subject matter herein to enable any person skilled in the art to make and use the embodiments. The scope of the subject matter embodiments is defined by the claims and may include other modifications that occur to those skilled in the art. Such other modifications are intended to be within the scope of the claims if they have similar elements that do not differ from the literal language of the claims or if they include equivalent elements with insubstantial differences from the literal language of the claims.

The embodiments herein can comprise hardware and software elements. The embodiments that are implemented in software include but are not limited to, firmware, resident software, microcode, etc. The functions performed by various modules described herein may be implemented in other modules or combinations of other modules. For the purposes of this description, a computer-usable or computer-readable medium can be any apparatus that can comprise, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid-state memory, magnetic tape, a removable computer diskette, a random-access memory (RAM), a read-only memory (ROM), a rigid magnetic disk and an optical disk. Current examples of optical disks include compact disk-read only memory (CD-ROM), compact disk-read/write (CD-R/W) and DVD.

Input/output (I/O) devices (including but not limited to keyboards, displays, pointing devices, etc.) can be coupled to the AI-based system 102 either directly or through intervening I/O controllers. Network adapters may also be coupled to the AI-based system 102 to enable the data processing system to become coupled to other data processing systems or remote printers or storage devices through intervening private or public networks. Modems, cable modem and Ethernet cards are just a few of the currently available types of network adapters.

A representative hardware environment for practicing the embodiments may include a hardware configuration of an information handling/AI-based system 102 in accordance with the embodiments herein. The AI-based system 102 herein comprises at least one processor or central processing unit (CPU). The CPUs are interconnected via the system bus 208 to various devices including at least one of: a random-access memory (RAM), read-only memory (ROM), and an input/output (I/O) adapter. The I/O adapter can connect to peripheral devices, including at least one of: disk units and tape drives, or other program storage devices that are readable by the AI-based system 102. The AI-based system 102 can read the inventive instructions on the program storage devices and follow these instructions to execute the methodology of the embodiments herein.

The AI-based system 102 further includes a user interface adapter that connects a keyboard, mouse, speaker, microphone, and/or other user interface devices including a touch screen device (not shown) to the bus to gather user input. Additionally, a communication adapter connects the bus to a data processing network, and a display adapter connects the bus to a display device which may be embodied as an output device including at least one of: a monitor, printer, or transmitter, for example.

A description of an embodiment with several components in communication with each other does not imply that all such components are required. On the contrary, a variety of optional components are described to illustrate the wide variety of possible embodiments of the invention. When a single device or article is described herein, it will be apparent that more than one device/article (whether or not they cooperate) may be used in place of a single device/article. Similarly, where more than one device or article is described herein (whether or not they cooperate), it will be apparent that a single device/article may be used in place of the more than one device or article, or a different number of devices/articles may be used instead of the shown number of devices or programs. The functionality and/or the features of a device may be alternatively embodied by one or more other devices which are not explicitly described as having such functionality/features. Thus, other embodiments of the invention need not include the device itself.

The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments. Also, the words “comprising,” “having,” “containing,” and “including,” and other similar forms are intended to be equivalent in meaning and be open-ended in that an item or items following any one of these words is not meant to be an exhaustive listing of such item or items or meant to be limited to only the listed item or items. It must also be noted that as used herein and in the appended claims, the singular forms “a,” “an,” and “the” include plural references unless the context clearly dictates otherwise.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that are issued on an application based here on. Accordingly, the embodiments of the present invention are intended to be illustrative, but not limiting, of the scope of the invention, which is set forth in the following claims.

What is claimed is:

1. An artificial intelligence (AI) based method for automatically generating one or more financial applications for one or more second users, the AI-based method comprising:
obtaining, by one or more hardware processors, one or more first data from one or more first electronic devices associated with one or more first users, wherein the one or more first data comprise at least one of: name, phone number, and address, of the one or more second users, one or more project categories, estimation of one or more projects, and time duration of the one or more projects being completed;
determining, by the one or more hardware processors, one or more first risk-based pricing options associated with the one or more projects based on the one or more first data obtained from the one or more first electronic devices associated with the one or more first users;
sending, by the one or more hardware processors, one or more application links to one or more second electronic devices associated with the one or more second users;
obtaining, by the one or more hardware processors, one or more second data from the one or more second electronic devices associated with the one or more second users, wherein the one or more second data comprise at least one of: the name, the phone number, the address, at least last four digits of a social security number (SSN), birth date, and annual income, of the one or more second users, an amount requested by the one or more second users, and an option for one or more third users to be added to the one or more second users;
determining, by the one or more hardware processors, whether the one or more second users are qualified to obtain one or more credits associated with the one or more projects using an artificial intelligence (AI) model, by:
obtaining, by the one or more hardware processors, the one or more second data from the one or more second electronic devices associated with the one or more second users;
pre-processing, by the one or more hardware processors, the one or more second data to generate one or more pre-processed data, wherein pre-processing the one or more second data comprises at least one of: normalizing the one or more second data to one or more standardized formats, identifying and managing one or more missing data fields in the one or more second data, and validating the one or more second data against one or more pre-defined data formats and ranges;
extracting, by the one or more hardware processors, one or more features from the one or more second data, wherein the one or more features comprise at least one of: a debt-to-income ratio, a credit utilization ratio, a payment history pattern, an employment stability indicator, a residential stability indicator, and an income verification indicator, of the one or more second users;
generating, by the one or more hardware processors, one or more integrated features by combining the extracted one or more features, wherein the one or more integrated features comprise at least one of: a financial stability score, a risk exposure indicator, and a repayment capacity indicator;
assigning, by the one or more hardware processors, one or more weights to each of at least one of: the one or more features and the one or more integrated features, wherein the one or more weights are assigned to each of at least one of: the one or more features and the one or more integrated features, based on historical loan performance data associated with one or more previous second users;
determining, by the one or more hardware processors, one or more qualification scores for the one or more second users based on the one or more weights assigned to each of at least one of: the one or more features and the one or more integrated features, using one or more functions, wherein the one or more functions comprise at least one of: a weighted sum function, a sigmoid function, a softmax function, and a probability distribution function; and
determining, by the one or more hardware processors, whether the one or more second users are qualified to obtain the one or more credits associated with the one or more projects based on the one or more qualification scores determined for the one or more second users;
sending, by the one or more hardware processors, the determined one or more first risk-based pricing options associated with the one or more projects to the one or more second electronic devices of the one or more second users when the one or more second users are qualified to obtain the one or more credits associated with the one or more projects;
determining, by the one or more hardware processors, whether the one or more second electronic devices of the one or more second users accept the one or more first risk-based pricing options associated with the one or more projects;
determining, by the one or more hardware processors, one or more second risk-based pricing options associated with the one or more projects when the one or more second electronic devices of the one or more second users reject the one or more first risk-based pricing options associated with the one or more projects;
obtaining, by the one or more hardware processors, one or more confirmed information associated with the one or more projects, from the one or more second electronic devices of the one or more second users, wherein the one or more confirmed information associated with the one or more projects comprise at least one of: one or more names associated with the one or more first users, one or more categories of works associated with the one or more projects, estimation of the works associated with the one or more projects, the time duration of the one or more projects, information associated with one or more ownerships, one or more categories of one or more properties of the one or more second users;
obtaining, by the one or more hardware processors, one or more third data associated with one or more identities (ID) of the one or more second users;
generating, by the one or more hardware processors, the one or more financial applications comprising one or more agreement based electronic documents for one or more payment processes, wherein the one or more agreement based electronic documents comprise at least one of: information associated with one or more credit amounts, and one or more truth in lending agreements (TILA); and
providing, by the one or more hardware processors, an output of the generated one or more financial applications in form of the one or more agreement based electronic documents on a user interface associated with the one or more second electronic devices of the one or more second users.

2. The AI-based method of claim 1, further comprising:
selecting, by the one or more hardware processors, the one or more projects from a list of one or more ongoing projects associated with the one or more second users;
generating, by the one or more hardware processors, one or more first options associated with the one or more projects, wherein the one or more first options comprise at least one of: creation of one or more payment requests, one or more update statuses of the one or more projects, one or more updated details of the one or more projects;
obtaining, by the one or more hardware processors, at least one first option associated with the one or more projects selected by the one or more first electronic devices of the one or more first users;
sending, by the one or more hardware processors, the at least one first option selected by the one or more first electronic devices of the one or more first users, to the one or more second electronic devices of the one or more second users;
determining, by the one or more hardware processors, whether the one or more second users accept the at least one first option through the one or more second electronic devices;
initiating, by the one or more hardware processors, the one or more payment processes when the one or more second electronic devices of the one or more second users accept the at least one first option; and
re-sending, by the one or more hardware processors, the at least one first option selected by the one or more first electronic devices of the one or more first users, to the one or more second electronic devices of the one or more second users, upon contacting with the one or more second users through the one or more second electronic devices when the one or more second users reject the at least one first option through the one or more second electronic devices.

3. The AI-based method of claim 1, further comprising training, by the one or more hardware processors, the AI model through a multi-stage training process, wherein the multi-stage training process comprises:
obtaining, by the one or more hardware processors, historical qualification data from one or more data sources, wherein the historical qualification data comprise at least one of: historical second data, historical qualification outcomes, historical loan performance data, and historical repayment data, associated with the one or more previous second users;
pre-processing, by the one or more hardware processors, the historical qualification data to generate pre-processed training data;
extracting, by the one or more hardware processors, one or more training features from the pre-processed training data;
configuring, by the one or more hardware processors, one or more hyperparameters for the AI model, wherein the one or more hyperparameters comprise at least one of: a learning rate, a batch size, a number of epochs, a number of hidden layers, a number of nodes in each hidden layer, a dropout rate, a regularization strength, a momentum value, and a decay rate;
training, by the one or more hardware processors, the AI model based on at least one of: the one or more training features, the historical qualification outcomes, and the one or more hyperparameters, to learn the one or more weights associated with the one or more training features;
validating, by the one or more hardware processors, performance of the trained AI model using validation data; and
deploying, by the one or more hardware processors, the trained AI model for determining whether the one or more second users are qualified to obtain the one or more credits associated with the one or more projects.

4. The AI-based method of claim 3, wherein validating the performance of the trained AI model using the validation data, comprises:
splitting, by the one or more hardware processors, the historical qualification data into training data and the validation data;
determining, by the one or more hardware processors, one or more performance metrics based on the validation data, wherein the one or more performance metrics comprise at least one of: an accuracy metric, a precision metric, a recall metric, an F1 score metric, an area under the receiver operating characteristic curve metric, and an area under the precision-recall curve metric;
performing, by the one or more hardware processors, hyperparameter tuning to adjust the one or more hyperparameters of the AI model based on the one or more performance metrics; and
retraining, by the one or more hardware processors, the AI model periodically based on updated historical qualification data, wherein the retraining of the AI model is triggered based on at least one of: a predetermined time interval, a predetermined number of new qualification determinations, and a detected decrease in the one or more performance metrics.

5. The AI-based method of claim 1, further comprising:
providing, by the one or more hardware processors, one or more second options to the one or more second electronic devices of the one or more second users to add the one or more third users; and
obtaining, by the one or more hardware processors, one or more fourth data associated with the one or more third users from at least one of: the one or more second electronic devices of the one or more second users and one or more third electronic devices of the one or more third users, wherein the one or more fourth data associated with the one or more third users comprise at least one of: the name, the phone number, the address, the at least last four digits of a social security number (SSN), the birth date, and the annual income, of the one or more third users.

6. The AI-based method of claim 1, further comprising:
determining, by the one or more hardware processors, whether the one or more second users hold at least one of: the one or more first risk-based pricing options and the one or more second risk-based pricing options, associated with the one or more projects within a predetermined time duration; and
sending, by the one or more hardware processors, one or more reminder messages to at least one of: the one or more first electronic devices of the one or more first users and the one or more second electronic devices of the one or more second users when the one or more second users hold at least one of: the one or more first risk-based pricing options and the one or more second risk-based pricing options, associated with the one or more projects within the predetermined time duration.

7. The AI-based method of claim 1, further comprising:
generating, by the one or more hardware processors, one or more summaries associated with the one or more credits upon mapping of the one or more second data with the one or more third data;
determining, by the one or more hardware processors, one or more credit qualifications of the one or more second users based on a hard pull process through a global distribution system (GDS); and
generating, by the one or more hardware processors, the one or more financial applications in the form of the one or more agreements for one or more payment processes when the one or more credit qualifications of the one or more second users exceed one or more predetermined values.

8. The AI-based method of claim 1, further comprising validating, by the one or more hardware processors, the one or more first users based on a clear identity confirm process, by:
obtaining, by the one or more hardware processors, one or more fifth data associated with the one or more first users from the one or more first electronic devices of the one or more first users;
comparing, by the one or more hardware processors, the one or more fifth data associated with the one or more first users with one or more first prestored data associated with the one or more first users retrieved from one or more clear databases;
generating, by the one or more hardware processors, one or more confidence scores for the one or more first users based on the comparison of the one or more fifth data associated with the one or more first users with the one or more first prestored data associated with the one or more first users;
classifying, by the one or more hardware processors, the one or more first users based on the one or more confidence scores generated for the one or more first users; and
determining, by the one or more hardware processors, whether the one or more first electronic devices of the one or more first users need to provide one or more sixth data based on the classification of the one or more first users.

9. The AI-based method of claim 8, further comprising:
obtaining, by the one or more hardware processors, one or more inputs from the one or more first electronic devices of the one or more first users, wherein the one or more inputs comprise a selection of one or more entities on which the one or more first users are belonging to;
comparing by the one or more hardware processors, the one or more inputs with one or more second prestored data based on a clear risk inform search process;
generating, by the one or more hardware processors, one or more risk scores for the one or more first users based on the comparison of the one or more inputs with the one or more second prestored data; and
determining, by the one or more hardware processors, one or more optimum first users based on the one or more risk scores generated for the one or more first users.

10. The AI-based method of claim 1, further comprising upon obtaining the one or more third data associated with the one or more identities of the one or more second users, performing, by the one or more hardware processors, an on-device identity and biometric security pipeline, by:
capturing, by one or more camera sensors of the one or more second electronic devices, one or more images of the one or more identities of the one or more second users;
performing, by the one or more hardware processors, ID classification and detection on-device by a custom machine learning model built using transfer learning based on a YOLOv8 architecture;
distinguishing, by the one or more hardware processors, a real ID card from look-alike documents comprising at least one of: credit cards and membership cards, using the custom machine learning model;
classifying, by the one or more hardware processors, an ID type and a state associated with the government-issued identification document, using the custom machine learning model;
extracting, by the one or more hardware processors, an ID template as a vector from the one or more valid documents associated with the one or more identities;
verifying, by the one or more hardware processors, the one or more identities of the one or more second users by submitting the ID template vector to a third-party DMV-integrated security service for server-side validation;
performing, by the one or more hardware processors, a liveness check locally on-device;
extracting, by the one or more hardware processors, a biometric vector from a face image of the one or more second users using a FaceNet embedding model;
generating, by the one or more hardware processors, a device blueprint by extracting device-specific features from the one or more second electronic devices;
running, by the one or more hardware processors, a customer confidence machine learning model over device features, transactional features, financial features, social features, and behavioral features;
generating, by the one or more hardware processors, a final security level based on outputs from at least one of: the ID verification, the liveness check, the biometric extraction, the device blueprint, and the customer confidence machine learning model; and
gating, by the one or more hardware processors, an onboarding flow via a rule engine based on the final security level, wherein the rule engine determines at least one of: a step-up action, a reject action, and a proceed action, associated with the one or more payment processes.

11. An artificial intelligence (AI) based system for automatically generating one or more financial applications for one or more second users, the AI-based system comprising:
one or more hardware processors;
a memory coupled to the one or more hardware processors, wherein the memory comprises a plurality of subsystems in form of programmable instructions executable by the one or more hardware processors, and wherein the plurality of subsystems comprises:
a data obtaining subsystem configured to obtain one or more first data from one or more first electronic devices associated with one or more first users, wherein the one or more first data comprise at least one of: a name, a phone number, and an address, of the one or more second users, one or more project categories, an estimation of one or more projects, and a duration of the one or more projects being completed;
a risk-based price determining subsystem configured to determine one or more first risk-based pricing options associated with the one or more projects based on the one or more first data obtained from the one or more first electronic devices associated with one or more first users;
a data transmission subsystem configured to send one or more application links to one or more second electronic devices associated with the one or more second users;
the data obtaining subsystem configured to obtain one or more second data from the one or more second electronic devices associated with the one or more second users, wherein the one or more second data comprise at least one of: the name, the phone number, the address, at least last four digits of a social security number (SSN), birth date, and annual income, of the one or more second users, an amount requested by the one or more second users, and an option for one or more third users to be added to the one or more second users;
a qualification determining subsystem configured to determine whether the one or more second users are qualified to obtain one or more credits associated with the one or more projects using an artificial intelligence (AI) model, by:
obtaining the one or more second data from the one or more second electronic devices associated with the one or more second users;
pre-processing the one or more second data to generate one or more pre-processed data, wherein pre-processing the one or more second data comprises at least one of: normalizing the one or more second data to one or more standardized formats, identifying and managing one or more missing data fields in the one or more second data, and validating the one or more second data against one or more pre-defined data formats and ranges;
extracting one or more features from the one or more second data, wherein the one or more features comprise at least one of: a debt-to-income ratio, a credit utilization ratio, a payment history pattern, an employment stability indicator, a residential stability indicator, and an income verification indicator, of the one or more second users;
generating one or more integrated features by combining the extracted one or more features, wherein the one or more integrated features comprise at least one of: a financial stability score, a risk exposure indicator, and a repayment capacity indicator;
assigning one or more weights to each of at least one of: the one or more features and the one or more integrated features, wherein the one or more weights are assigned to each of at least one of: the one or more features and the one or more integrated features, based on historical loan performance data associated with one or more previous second users;
determining one or more qualification scores for the one or more second users based on the one or more weights assigned to each of at least one of: the one or more features and the one or more integrated features, using one or more functions, wherein the one or more functions comprise at least one of: a weighted sum function, a sigmoid function, a softmax function, and a probability distribution function; and
determining whether the one or more second users are qualified to obtain the one or more credits associated with the one or more projects based on the one or more qualification scores determined for the one or more second users;
the data transmission subsystem further configured to send the determined one or more first risk-based pricing options associated with the one or more projects to the one or more second electronic devices of the one or more second users when the one or more second users are qualified to obtain the one or more credits associated with the one or more projects;
the risk-based price determining subsystem further configured to:
determine, whether the one or more second electronic devices of the one or more second users accept the one or more first risk-based pricing options associated with the one or more projects; and
determine one or more second risk-based pricing options associated with the one or more projects when the one or more second electronic devices of the one or more second users reject the one or more first risk-based pricing options associated with the one or more projects;
the data obtaining subsystem further configured to:
obtain one or more confirmed information associated with the one or more projects, from the one or more second electronic devices of the one or more second users, wherein the one or more confirmed information associated with the one or more projects comprise at least one of: one or more names associated with the one or more first users, one or more categories of works associated with the one or more projects, estimation of the works associated with the one or more projects, the time duration of the one or more projects, information associated with one or more ownerships, one or more categories of one or more properties of the one or more second users; and
obtain one or more third data associated with one or more identities of the one or more second users;
a financial application generation subsystem configured to generate the one or more financial applications comprising one or more agreement based electronic documents for one or more payment processes, wherein the one or more agreement based electronic documents comprise at least one of: information associated with one or more credit amounts, and one or more truth in lending agreements (TILA); and
an output subsystem configured to provide an output of the generated one or more financial applications in form of the one or more agreement based electronic documents on a user interface associated with the one or more second electronic devices of the one or more second users.

12. The AI-based system of claim 11, further comprising a payment processing subsystem configured to:
select the one or more projects from a list of one or more ongoing projects associated with the one or more second users;
generate one or more first options associated with the one or more projects, wherein the one or more first options comprise at least one of: creation of one or more payment requests, one or more update statuses of the one or more projects, one or more updated details of the one or more projects;
obtain at least one first option associated with the one or more projects selected by the one or more first electronic devices of the one or more first users;
send the at least one first option selected by the one or more first electronic devices of the one or more first users, to the one or more second electronic devices of the one or more second users;
determine whether the one or more second users accept the at least one first option through the one or more second electronic devices;
initiate the one or more payment processes when the one or more second electronic devices of the one or more second users accept the at least one first option; and
re-send the at least one first option selected by the one or more first electronic devices of the one or more first users, to the one or more second electronic devices of the one or more second users, upon contacting with the one or more second users through the one or more second electronic devices when the one or more second users reject the at least one first option through the one or more second electronic devices.

13. The AI-based system of claim 11, further comprising a training subsystem configured to train the AI model through a multi-stage training process, wherein the multi-stage training process comprises:
obtaining historical qualification data from one or more data sources, wherein the historical qualification data comprise at least one of: historical second data, historical qualification outcomes, historical loan performance data, and historical repayment data, associated with the one or more previous second users;
pre-processing the historical qualification data to generate pre-processed training data;
extracting one or more training features from the pre-processed training data;
configuring one or more hyperparameters for the AI model, wherein the one or more hyperparameters comprise at least one of: a learning rate, a batch size, a number of epochs, a number of hidden layers, a number of nodes in each hidden layer, a dropout rate, a regularization strength, a momentum value, and a decay rate;
training the AI model based on at least one of: the one or more training features, the historical qualification outcomes, and the one or more hyperparameters, to learn the one or more weights associated with the one or more training features;
validating performance of the trained AI model using validation data; and
deploying the trained AI model for determining whether the one or more second users are qualified to obtain the one or more credits associated with the one or more projects.

14. The AI-based system of claim 13, wherein in validating the performance of the trained AI model using the validation data, the training subsystem is further configured to:
split the historical qualification data into training data and the validation data;
determine one or more performance metrics based on the validation data, wherein the one or more performance metrics comprise at least one of: an accuracy metric, a precision metric, a recall metric, an F1 score metric, an area under the receiver operating characteristic curve metric, and an area under the precision-recall curve metric;
perform hyperparameter tuning to adjust the one or more hyperparameters of the AI model based on the one or more performance metrics; and
retrain the AI model periodically based on updated historical qualification data, wherein the retraining of the AI model is triggered based on at least one of: a predetermined time interval, a predetermined number of new qualification determinations, and a detected decrease in the one or more performance metrics.

15. The AI-based system of claim 11, further comprising a user addition subsystem configured to:
provide one or more second options to the one or more second electronic devices of the one or more second users to add the one or more third users; and
obtain one or more fourth data associated with the one or more third users from at least one of: the one or more second electronic devices of the one or more second users and one or more third electronic devices of the one or more third users, wherein the one or more fourth data associated with the one or more third users comprise at least one of: the name, the phone number, the address, the at least last four digits of a social security number (SSN), the birth date, and the annual income, of the one or more third users.

16. The AI-based system of claim 11, wherein the risk-based price determining subsystem is further configured to:
determine whether the one or more second users hold at least one of: the one or more first risk-based pricing options and the one or more second risk-based pricing options, associated with the one or more projects within a predetermined time duration; and
send one or more reminder messages to at least one of: the one or more first electronic devices of the one or more first users and the one or more second electronic devices of the one or more second users when the one or more second users hold at least one of: the one or more first risk-based pricing options and the one or more second risk-based pricing options, associated with the one or more projects within the predetermined time duration.

17. The AI-based system of claim 11, wherein the financial application generation subsystem is further configured to:
generate one or more summaries associated with the one or more credits upon mapping of the one or more second data with the one or more third data;
determine one or more credit qualifications of the one or more second users based on a hard pull process through a global distribution system (GDS); and
generate the one or more financial applications in the form of the one or more agreements for one or more payment processes when the one or more credit qualifications of the one or more second users exceed one or more predetermined values.

18. The AI-based system of claim 11, further comprising a user validation subsystem configured to validate the one or more first users based on a clear identity confirm process, wherein in validating the one or more first users based on the clear identity confirm process, the user validation subsystem is further configured to:
obtain one or more fifth data associated with the one or more first users from the one or more first electronic devices of the one or more first users;
compare the one or more fifth data associated with the one or more first users with one or more first prestored data associated with the one or more first users retrieved from one or more clear databases;
generate one or more confidence scores for the one or more first users based on the comparison of the one or more fifth data associated with the one or more first users with the one or more first prestored data associated with the one or more first users;
classify the one or more first users based on the one or more confidence scores generated for the one or more first users; and
determine whether the one or more first electronic devices of the one or more first users need to provide one or more sixth data based on the classification of the one or more first users,
wherein the user validation subsystem is further configured to:
obtain one or more inputs from the one or more first electronic devices of the one or more first users, wherein the one or more inputs comprise a selection of one or more entities on which the one or more first users are belonging to;
compare the one or more inputs with one or more second prestored data based on a clear risk inform search process;
generate one or more risk scores for the one or more first users based on the comparison of the one or more inputs with the one or more second prestored data; and
determine one or more optimum first users based on the one or more risk scores generated for the one or more first users.

19. The AI-based system of claim 11, upon obtaining the one or more third data associated with the one or more identities of the one or more second users, the AI-based system is further configured to perform an on-device identity and biometric security pipeline, by:
capturing one or more images of the one or more identities of the one or more second users using one or more camera sensors of the one or more second electronic devices;
performing ID classification and detection on-device by a custom machine learning model built using transfer learning based on a YOLOv8 architecture;
distinguishing a real ID card from look-alike documents comprising at least one of: credit cards and membership cards, using the custom machine learning model;
classifying an ID type and a state associated with the government-issued identification document, using the custom machine learning model;
extracting an ID template as a vector from the one or more valid documents associated with the one or more identities;
verifying the one or more identities of the one or more second users by submitting the ID template vector to a third-party DMV-integrated security service for server-side validation;
performing a liveness check locally on-device;
extracting a biometric vector from a face image of the one or more second users using a FaceNet embedding model;
generating a device blueprint by extracting device-specific features from the one or more second electronic devices;
running a customer confidence machine learning model over device features, transactional features, financial features, social features, and behavioral features;
generating a final security level based on outputs from at least one of: the ID verification, the liveness check, the biometric extraction, the device blueprint, and the customer confidence machine learning model; and
gating an onboarding flow via a rule engine based on the final security level, wherein the rule engine determines at least one of: a step-up action, a reject action, and a proceed action, associated with the one or more payment processes.

20. A non-transitory computer-readable storage medium having instructions stored therein that when executed by a hardware processor, cause the processor to execute operations of:
obtaining one or more first data from one or more first electronic devices associated with one or more first users, wherein the one or more first data comprise at least one of: name, phone number, and address, of the one or more second users, one or more project categories, estimation of one or more projects, and time duration of the one or more projects being completed;
determining one or more first risk-based pricing options associated with the one or more projects based on the one or more first data obtained from the one or more first electronic devices associated with the one or more first users;
sending one or more application links to one or more second electronic devices associated with the one or more second users;
obtaining one or more second data from the one or more second electronic devices associated with the one or more second users, wherein the one or more second data comprise at least one of: the name, the phone number, the address, at least last four digits of a social security number (SSN), birth date, and annual income, of the one or more second users, an amount requested by the one or more second users, and an option for one or more third users to be added to the one or more second users;
determining whether the one or more second users are qualified to obtain one or more credits associated with the one or more projects using an artificial intelligence (AI) model, by:
obtaining the one or more second data from the one or more second electronic devices associated with the one or more second users;
pre-processing the one or more second data to generate one or more pre-processed data, wherein pre-processing the one or more second data comprises at least one of: normalizing the one or more second data to one or more standardized formats, identifying and managing one or more missing data fields in the one or more second data, and validating the one or more second data against one or more pre-defined data formats and ranges;
extracting one or more features from the one or more second data, wherein the one or more features comprise at least one of: a debt-to-income ratio, a credit utilization ratio, a payment history pattern, an employment stability indicator, a residential stability indicator, and an income verification indicator, of the one or more second users;
generating one or more integrated features by combining the extracted one or more features, wherein the one or more integrated features comprise at least one of: a financial stability score, a risk exposure indicator, and a repayment capacity indicator;
assigning one or more weights to each of at least one of: the one or more features and the one or more integrated features, wherein the one or more weights are assigned to each of at least one of: the one or more features and the one or more integrated features, based on historical loan performance data associated with one or more previous second users;
determining one or more qualification scores for the one or more second users based on the one or more weights assigned to each of at least one of: the one or more features and the one or more integrated features, using one or more functions, wherein the one or more functions comprise at least one of: a weighted sum function, a sigmoid function, a softmax function, and a probability distribution function; and
determining whether the one or more second users are qualified to obtain the one or more credits associated with the one or more projects based on the one or more qualification scores determined for the one or more second users;
sending the determined one or more first risk-based pricing options associated with the one or more projects to the one or more second electronic devices of the one or more second users when the one or more second users are qualified to obtain the one or more credits associated with the one or more projects;
determining whether the one or more second electronic devices of the one or more second users accept the one or more first risk-based pricing options associated with the one or more projects;
determining one or more second risk-based pricing options associated with the one or more projects when the one or more second electronic devices of the one or more second users reject the one or more first risk-based pricing options associated with the one or more projects;
obtaining one or more confirmed information associated with the one or more projects, from the one or more second electronic devices of the one or more second users, wherein the one or more confirmed information associated with the one or more projects comprise at least one of: one or more names associated with the one or more first users, one or more categories of works associated with the one or more projects, estimation of the works associated with the one or more projects, the time duration of the one or more projects, information associated with one or more ownerships, one or more categories of one or more properties of the one or more second users;
obtaining one or more third data associated with one or more identities of the one or more second users;
generating the one or more financial applications comprising one or more agreement based electronic documents for one or more payment processes, wherein the one or more agreement based electronic documents comprise at least one of: information associated with one or more credit amounts, and one or more truth in lending agreements (TILA); and
providing an output of the generated one or more financial applications in form of the one or more agreement based electronic documents on a user interface associated with the one or more second electronic devices of the one or more second users.
